(19) United States
(12) Patent Application Publication
(10) Pub. No.: US 2006/0090063 A1
(43) Pub. Date: Apr. 27, 2006

(54) Method for executing structured symbolic machine code on a microprocessor

(76) Inventor: Jean-Paul Theis, Hamburg (DE)

Correspondence Address: Ante Vista Gmbh;Harburger Schlossstrasse 6-12, 21079 Hamburg, Germany, DE

(21) Appl. No.: 10/521,585

(22) PCT Filed: Jan. 8, 2003
(86) PCT No.: PCT/EP03/00099

§ 371 Date: Jan. 18, 2005

(51) Int. Cl. G06F 9/00

(52) U.S. Cl. 712/239

(57) ABSTRACT

The invention describes a method for executing structured symbolic machine code on a microprocessor. Said structured symbolic machine code contains a set of one or more regions, where each of said regions contains symbolic machine code containing, in addition to the proper instructions, information about the symbolic variables, the symbolic constants, the branch tree, pointers and functions arguments used within each of said regions. This information is fetched by the microprocessor from the instruction cache and stored into dedicated memories before the proper instructions of each region are fetched and executed. Said information is used by the microprocessor in order to improve the degree of parallelism achieved during instruction scheduling and execution. Among other purposes, said information allows the microprocessor to perform so-called speculative branch prediction. Speculative branch prediction does branch prediction along a branch path containing several dependent branches in the shortest time possible (in only a few clock cycles) without having to wait for branches to resolve. This is a key issue which allows to apply region scheduling in practice, e.g. treegion scheduling, where machine code must be fetched and speculatively executed from the trace having highest probability or confidence among several traces. This allows to use the computation resources (e.g. the FUs) of the microprocessor in the most efficient way. Finally, said information allows to re-execute instructions in the right order and to overwrite wrong data with the correct ones when miss-predictions occur.

### 1. FIELD OF THE INVENTION

The present invention relates to the interdisciplinary field of computer hardware and software, in particular to the interactions of instruction set design with microprocessor design. More specifically, the invention describes a method which describes how a microprocessor uses the information contained in structured symbolic machine code in order to execute such code.

### 2. CONVENTIONS, DEFINITION OF TERMS, TERMINOLOGY

If not explicitly mentioned otherwise, the terms defined in this section are identical to those found in the literature. A good reference book on the subject is f. ex. ‘Computer Architecture: A Quantitative Approach, J. Hennessy and D. Patterson, Morgan Kaufmann Publishers, 1996’. However, in order to ease the terminology, in the context of the present invention the term ‘microprocessor’ has a broader meaning than usually found in the literature and may stand for any data processing system in general, and in particular for central processing units (CPU), digital signal processors (DSP), any special-purpose (graphics) processor or any application specific instruction set processor (ASIP), whether embedded, whether being part of a chip-multi-processor system (CMP) or whether stand-alone.

One of the main characteristics of a microprocessor is the fact that it has an instruction set. In other words, some machine code which is running or executed on said microprocessor, contains instructions belonging to said instruction set. Said machine code is usually obtained either by compiling a source code, e.g. a program written some high level programming language like C++, or by manual writing. Each instruction of a said instruction set has an instruction format. Furthermore, said microprocessor may have several different instruction formats such that instructions of a machine code may have different instruction formats. When said machine is running or executed on said microprocessor, this means that instructions contained in said machine code are executed on said microprocessor.

As usual, the term ‘instruction format’ refers to a sequence of bit-fields of a certain length. Said bit-fields may be of different length. An instruction format usually contains a so called ‘opcode’ bit-field and one or more ‘operand’ bit-fields. The ‘opcode’ bit-field encodes (defines) a specific instruction among all the instructions of an instruction set, e.g. the addition of two numbers or the loading of data from memory or a cache. In the following, instructions which are specified by an ‘opcode’ bit-field are also called ‘explicit’ instructions, this in order to stress the difference with ‘implicit’ instructions which will be defined further below. The ‘operand’ bit-fields specify (encode) the operands of the instruction. In other words, an instruction is a data operation which is specified by (encoded in) the ‘opcode’ bit-field and where the data (or operands) used by said operation are specified by (encoded in) the ‘operand’ bit-fields. Usually, the operands often specify (or are often given in form of) memory references, memory locations (addresses) or registers and the values of the instruction operands are stored to or loaded from said memory addresses or registers. Said memory references and memory locations refer to addresses within the memory system coupled to said microprocessor. As will be discussed in more detail below, said memory system usually has an a memory hierarchy comprising memories at different hierarchy levels such as register files of the microprocessor, L1 and L2 data caches and main memory. In case that instruction operands and/or results specify registers within a register file of said microprocessor, these registers are specified by (or encoded in) said ‘operand’ bit-fields. E.g. in case of a microprocessor with a register file containing 128 registers, an ‘operand’ bit-field of at least 7 bits is required to uniquely specify (or encode) a register inside the register file.

In so-called 3-address machines, the instruction format contains also a ‘destination’ bit-field in addition to the ‘operand’ bit-fields, which specifies where the result of said instruction (or data operation) has to be stored. E.g. the result of an arithmetic instruction like an addition of two numbers is equal to the sum of said numbers. The result (or the outcome) of ‘compare’-instructions comparing two numbers x and y, e.g. instructions like ‘x equal-to y’, ‘y smaller-than y’, ‘x greater-than y’ etc . . . , is equal to a boolean value of either ‘0’ or ‘1’ depending on whether the comparison is true or false. In case of so-called 2-address machines, one of said ‘operand’ bit-fields is at the same time ‘destination’ bit-field such that the operand specified by said ‘operand’ bit-field is at the same time ‘destination’ of said instruction. As for operands, destinations are usually given in form of memory references, memory locations (addresses) or in form of registers and the values of the instruction results are stored to or loaded from said memory addresses or registers. Furthermore, ‘compare’-instructions often write their results (often called ‘flag-bits’) into dedicated destinations like status-registers, flag-registers or predication registers. Usually, there are no ‘destination’ bit-fields in the instruction format specifying flag-registers and status-registers.

In the context of the present invention, the length and the order of the bit-fields making up the format of an instruction is not relevant. In other words, it doesn't matter whether the ‘opcode’ bit-field is preceding the ‘operand’ bit-fields or vice versa nor does the order of the ‘operand’ bit-fields among each other matter. The encoding of the bit-fields is not relevant as well. Furthermore, instruction formats may be of fixed or of variable length and may contain a fixed number or a variable number of operands. In case of a variable instruction format length and a variable number of operands, additional bit-fields may be spent for these purposes. However, format length and number of operands may also be part of the ‘opcode’ bit-field. Also, an ‘operand’ bit-field is often given in form of an ‘address specifier’ bit-field and an ‘address’ bit-field. The ‘address specifier’ bit-field determines the addressing mode for the considered operand, e.g. indirect addressing, offset addressing etc . . . , whereas the ‘address’ bit-field determines the address of the considered operand within the memory system or memory hierarchy linked or coupled to the microprocessor (see below for more details about the memory hierarchy).

It is assumed in the following that said microprocessor contains one or more functional units (FUs) such that one or more instructions may be fetched, decoded and executed in parallel. These FUs may be arithmetic logic units (ALUs), floating point units (FPUs), load/store units (LSUs), branch units (BUs) or any other functional units. From a hardware point of view, when some machine code is running on a said microprocessor it means that the instructions of said machine code are executed on the FUs of said microprocessor. As mentioned previously, data are used (read) and generated (written) by instructions in form of instruction operands and results. When an instruction is executed on a FU, it performs a number of data operations in the widest sense, e.g. any loading, storing or computing of data. If instructions generate (or compute or produce) data, then these data correspond to the results of the (data) operations performed by said instructions. These results are also called instruction results. E.g. an ‘ADD’ instruction reads two operands and generates a result equal to the sum of the two operands. Therefore, the set of data used by a machine code running on said microprocessor is part of the set of data used in form of (the values of) instruction operands of said machine code. Similarly, the data generated by a machine code running on said microprocessor is part of the set of data generated in form (of the values of) instructions results of said machine code.

In the context of the present invention, an ‘implicit’ instruction is defined to be an instruction which is known by the microprocessor prior to execution of said instruction and where said instruction has not to be specified by an ‘opcode’ bit-field or any other bit-field in an instruction format of said instruction. However, as mentioned before, an ‘implicit’ instruction may well have one or more operands and one or more destinations specified in corresponding bit-fields of said instruction format. It is also possible that an ‘implicit’ instruction may have no operands and no destination specified in any bit-field of the instruction format. In this case, the ‘implicit’ instruction may be f. ex. a special-purpose instruction which initializes some hardware circuitry of the microprocessor or has some other well defined meaning or purpose.

Always in the context of a machine code running on a said microprocessor, an ‘implicit and potential’ instruction is an ‘implicit’ instruction where the results or the outcome of instructions which have not yet finished execution decide whether:
1) said ‘implicit and potential’ instruction shall be executed or not
2) an already commenced execution of said ‘implicit and potential’ instruction is valid or not or shall be canceled or not
3) the result of a said ‘implicit and potential’ instruction which has finished execution is valid or not

In other words, the execution of an ‘implicit and potential’ instruction is delayed and is decided upon until other instructions have finished execution, although said instruction may have already entered an instruction pipeline stage like f. ex. a ‘fetch’ or ‘decode’-stage. It is important to see that ‘predicated’ instructions are special cases of ‘implicit and potential’ instructions.

Two small examples shall clarify the meaning of an ‘implicit’ instruction’ and an ‘implicit and potential’ instruction.

E.g. assume a microprocessor having an instruction format and running a machine code containing instructions out of said instruction set. Furthermore, assume that said instruction format contains two ‘operand’ bit-fields and no other bit-fields. Furthermore, assume that said microprocessor has to execute an instruction having said instruction format and that said two bit-fields specify two operands designated f. ex. by ‘op1’ and ‘op2’. In this case, an example of an ‘implicit instruction’ associated with these two operands can be any kind of instruction (or data operation) like the addition or the multiplication of these two operands or the loading of these two operands from a memory or a register file etc. . . . , and where said implicit instruction can be specified f. ex. by convention for the whole time of execution of said machine code or can be specified by another instruction which was executed prior to said instruction. An example of an ‘implicit and potential instruction’ associated with these two operands is f. ex. a load- or a move-instruction which is loading the two operands from some memory 1) only after certain instructions not yet executed have been executed and 2) only if the outcome of the results of said instructions satisfy certain conditions.

Within the scope of the present invention, it is assumed that said microprocessor has means (hardware circuitry) to measure time by using some method, otherwise machine code that is running on said microprocessor may produce wrong data or wrong results. Said terms ‘measure time’ or ‘time measurement’ have a very broad meaning and implicitly assume the definition of a time axis and of a time unit such that all points in time, time intervals, time delays or any arbitrarily time events refer to said time axis. Said time axis can be defined by starting to measure the time that elapses from a certain point in time onwards, this point in time usually being the point in time when said microprocessor starts operation and begins to execute a said machine code. Said time unit, which is used to express the length of time intervals and time delays as well as the position on said time axis of points in time or any other time events, may be a physical time unit (e.g. nanosecond) or a logical time unit (e.g. the cycle of a clock used by a synchronously clocked microprocessor).

Synchronously clocked microprocessors use the cycles, the cycle times or the periods of one or more periodic clock signals to measure time. In the text that follows, a clock signal is referred to simply as a clock. However, the cycle of a said clock may change over time or during execution of a machine code on said microprocessor, e.g. the SpeedStep Technology used by Intel Corporation in the design of the Pentium IV microprocessor. Asynchronously clocked microprocessors use the travel times required by signals to go through some specific hardware circuitry as time units. In case of a synchronously clocked microprocessor, said time axis can be defined by starting to count and label the clock cycles of a said clock from a certain point in time onwards, this point in time usually being the point in time when said microprocessor starts operation and begins to execute machine code.

Therefore, if said microprocessor is able to measure time, then this means that said microprocessor is able find to out the chronological order of any two points in time or of any two time events on said time axis. In the case of a synchronously clocked microprocessor, this is done by letting said microprocessor operate with a clock in order to measure time with multiples (maybe integer or fractional) of the cycle of said clock, where one cycle of said clock can be seen as a logical time unit. Furthermore, the clock which is used to measure time is often the clock with the shortest cycle time such that said cycle is the smallest time unit (logical or physical) used by a synchronously clocked microprocessor in order to perform instruction scheduling and execution, e.g. to schedule all internal operations and actions necessary to execute a given machine code in a correct way.

However the scope of the present invention is independent of whether said microprocessor is synchronously clocked or whether it uses asynchronous clocking, asynchronous timing or any other operating method or timing method to run and execute machine code.

The so-called execution state of a machine code (often called the program counter state) running on said microprocessor usually denotes the point in time when the latest instruction was fetched, decoded or executed. If one assumes that said microprocessor operates with some synchronous clock, then another possibility consists in defining the execution state in form of an integer number which is equal to the number of clock cycles of said clock which have elapsed since said machine code has started execution on said microprocessor. Therefore, usually the execution state is incremented from clock to clock cycle as long as said machine code is running. For illustration purposes, we will assume in the following that the execution state of a machine code at a given point in time during execution of said machine code on said microprocessor is given in form of a numerical value representing a point in time on said time axis.

Whatever the clocking scheme or the operating method (synchronous or asynchronous) or the time measurement method used by said microprocessor, it is usual that instructions are pipelined. This means that:
1) said microprocessor has one or more instruction pipelines which contain each several (pipeline) stages and that instructions may take each different amounts of time (in case of a synchronously clocked microprocessor: several cycles of said clock) to go through the different stages of a said instruction pipeline before completing execution. The first pipeline stage is usually a ‘prefetch’ stage, followed by ‘decode’ and ‘dispatch’ stages, the last pipeline stage being often a ‘write back’ or an ‘execution’ stage. One often speaks of different phases through which an instruction has to go, e.g. ‘fetch’, ‘decode’, ‘dispatch’, ‘execute’, ‘write-back’ phases etc., each phase containing several pipeline stages. Therefore, the execution of an instruction may include the pipeline stages (and the amount of time) which are required to write or to store or to save operands or results into some memory location, e.g. into a register, into a cache or into main memory. In the case of a synchronously clocked microprocessor, multiples (integer or fractional) of the cycle of said clock can be used as well to specify the depth and the number of the instruction pipeline stages of said microprocessor. The number of pipeline stages that a given instruction has to go through is often called the latency of said instruction. In case of a synchronously clocked microprocessor, said latency is often given in cycle units of a clock.

An instruction is said to be executed or to have commenced execution if said instruction has entered a certain pipeline stage, and where said pipeline stage is often the first stage of the execution phase. An instruction is said to have finished execution if it has left a certain pipeline stage, said pipeline stage being often the last stage of the execution phase. The point in time (on said time axis) at which a given instruction enters a pipeline stage is called the ‘entrance point’ of said instruction into said pipeline stage. The point in time at which a given instruction leaves a pipeline stage is called the ‘exit point’of said instruction out of said pipeline stage.

Usually, the operating principles of instruction pipelines are such that if an instruction enters a certain pipeline stage then said instruction triggers certain operations or events internal to the microprocessor (also called micro-operations) which are required to manipulate the data used (e.g. the operands) or generated (e.g. the results) by the instruction in a correct way. Said micro-operations are determined by the functionality of said pipeline stage and are usually part of the so-called micro-code of said instruction. Therefore, micro-code and micro-operations usually differ from pipeline stage to pipeline stage. Note that micro-code has not to be confused with machine code.
2) an instruction may enter a stage of an instruction pipeline before another instruction has left another stage of the same instruction pipeline. E.g. if an instruction pipeline has 4 stages denoted by P1, P2, P3, P4, then an instruction A1 may enter stage P2 at some point in time t1 while another instruction labeled by B1 enters stage P4 at the same point in time t1. It is also possible that the instruction pipeline of said microprocessor is such that instruction A1 may enter a stage before another instruction B1 has left the same stage.

The term instruction pipeline is still valid and keeps the same meaning even if instructions are not pipelined. In this case, an instruction pipeline has one single stage. In case of a synchronously clocked microprocessor, an instruction usually takes one cycle of a said clock to go through one stage of an instruction pipeline. Typical depths of instruction pipelines of prior-art microprocessors range between 5 to 15 stages. E.g. the Pentium IV processor of Intel Corporation has an instruction pipeline containing 20 stages such that instructions may require up to 20 clock cycles to go through the entire pipeline, whereas the Alpha 21264 processor from Compaq has only 7 stages.

In the following, the terms ‘instruction scheduling’ and ‘instruction execution’ play an important role. We give first of all a broader definition of these terms as follows:
in the context of a microprocessor executing some machine code, the terms ‘instruction scheduling’ and ‘instruction execution’ refer to the determination of the points in time of a time axis (as defined above) at which some operations or some time events are occurring (or are taking place) within said microprocessor in order to allow for a correct execution of machine code on said microprocessor

A definition of the previous terms which is closer to a physical use and implementation of an instruction format as based on the present invention and which is included in and is a special case of the previous definition, is as follows:
the terms ‘instruction scheduling’ and ‘instruction execution’ refer to the determination of the points in time on said time axis at which a given instruction of a machine code running on said microprocessor enters or leaves one or more stages of an instruction pipeline of said microprocessor in order to complete (finish) execution. In case of a synchronously clocked microprocessor, said points in time can be integer or fractional multiples of a cycle, cycle time or period of a clock.

Usually, within superscalar microprocessors, the points in time at which said instructions enter the different pipeline stages cannot be predicted and are not known prior to machine code execution. More specifically, the points in time when instructions enter the different pipeline stages depend e.a. on the following parameters:
the validness of instruction operands and results, determined by the data dependencies between instructions
on the available space within the memory hierarchy
on the access bandwidths of the memories of the memory system

Because of the non-deterministic nature of these parameters, one often speaks of dynamic instruction scheduling and execution performed internally by the microprocessor during machine code execution. It is clear that said microprocessor must have hardware means (e.g. hardware blocks like fetch, decode & dispatch units, reservation stations, memory disambiguation units etc . . . ) in order to be able to perform dynamic instruction scheduling. Therefore, dynamic instruction scheduling has not to be confused with static instruction scheduling performed by compilers for generating machine code. Static instruction scheduling is based on deterministic algorithms like software pipelining, list or trace scheduling and pursues the goal of determining a sequential order of instructions within said machine code such that it can be executed in a correct and efficient way on said microprocessor by using dynamic instruction scheduling. Dynamic instruction scheduling analyzes the machine code generated by static instruction scheduling, and based on the above parameters determines when instructions are fetched, decoded and executed.

As mentioned before, said microprocessor is part of a data processing system containing a memory system and a memory hierarchy where the data used and generated by some machine code running on said microprocessor are stored to and loaded from. Usually, the terms ‘memory system’ and ‘memory hierarchy’ are defined such as to comprise the following memories:
(1) one or more register file(s) being part of said microprocessor
(2) one or more data caches at different memory hierarchy levels, e.g. L1 and L2 data caches
(3) a main memory
(4) one or more read/write buffers of said microprocessor

When data are moved from one memory of the memory hierarchy to another one or between the microprocessor and a memory of the memory hierarchy, then they may be stored temporarily within these read/write buffers. The moving of data may be caused by instructions of a machine code being executed on said microprocessor or may performed by data caching strategies, e.g. random or least-recently used (LRU) data replacement upon data read/write-misses within data caches. Furthermore, said read/write buffers can be bypassed by the microprocessor if required and may not be visible or specifiable for the programmer or within the instruction format.

The memories of the memory hierarchy usually have different access times (latencies) for reading or writing data. The access time for reading/writing data is the time required to load/store data from/to a specific memory address respectively. The term ‘memory hierarchy level’ usually refers to an upwards or downwards sorting and labeling of the memory hierarchy levels of the memory system according to the access times for data read and data write of the different memories. E.g., if a memory A has a shorter access time for writing data than a memory B, then said memory A has either a lower or a higher hierarchy level than said memory B, depending on which sorting scheme was chosen.

Usually, if a memory A has a shorter access time for writing data than another memory, then usually memory A has also a shorter access time for reading data than the other memory.

The next concept which plays an important role in the context of the present invention is that of the lifetimes of a datum generated and used by during execution of some machine code on said microprocessor. The definition given here is a generalization of those usually found in the literature and considers also the case where a value is read by an instruction and then read again some time later by another instruction. Formally, the lifetime of a datum is defined to be a time interval on said time axis where said time interval is defined by two points in time (also called end points) as follows:
(1) the point in time when said datum is written or read by an instruction starting execution on one of the FUs of the microprocessor
(2) the point in time when said datum are written or read again by instructions starting execution on one of the FUs of the microprocessor

Clearly, the data lifetimes depend on when instructions are executed, hence on instruction scheduling. If instructions of a machine code are scheduled using static scheduling, then most of the data lifetimes can be exactly calculated before executing said machine code, by relying f. ex. on array data flow analysis. If instructions are dynamically scheduled (as is the case for most of today's microprocessors), then most of the data lifetimes are exactly known only after instructions have started executing. However, even for dynamic instruction scheduling, data lifetimes can be estimated by using a combination of array data flow analysis, branch profiling and on worst and best case static instruction scheduling (e.g. asap-schedules (as soon as possible)) without having to execute the machine code. A precise example in section 4 shall illustrate how data life times can be either exactly calculated or estimated by using array data flow analysis and static scheduling.

Furthermore, data may be written and read into the same memory locations or memory addresses several times and this at different points in time. In this case, minimal and maximal data lifetimes are determined by the points in time where data are reused for the first and for the last time respectively. For the scope of the present invention however, it is not relevant whether the mentioned data lifetimes refer to exactly calculated or estimated lifetimes, whether minimal, maximal or somewhere between. Finally, data lifetimes are usually expressed in some time unit of said time axis. This can be in form of integer or fractional numbers. Fractional numbers usually refer to some physical time unit (e.g. in [ns]) while integer numbers are often given in cycle units of some reference clock of said microprocessor.

As mentioned in the beginning of this section, machine code is usually generated by a compiler which compiles a source code program written in some high level programming language. A so-called region of said source code program is a part (or portion) of said source code. E.g., assuming a source code program written in C++, a region may be:
a function definition
a class or a method
a compound statement
an expression
an iterative statement, e.g. a ‘for’- or ‘while’-loop
a selection statement, e.g. an ‘if-then-else’ statement
etc. . . .

It is clear that a region can be an arbitrarily complex and large portion of a source code program. E.g. the function main( ) in a C-program can be seen as a region. The same for a compound statement containing a large number of nested selection and/or iterative statements, etc . . .

The notion of region is also applicable to (symbolic) machine code. A region of a (symbolic) machine code is often called a thread. Hence, given a source code program and a machine code obtained by compiling said source code program, a thread (or a region of said machine code) associated with a portion (or a part) of said source code program is machine code obtained by compiling the portion of said source code program. As for a region of a source code program, it is clear that a thread can be arbitrarily complex. Special cases of threads (or regions) will be discussed further below.

As usual, each instruction in a machine code has an address, called the instruction address. The set of the addresses of all instructions of a machine code is called the machine code address space. It is clear that the instruction addresses are used by the instruction fetch unit of the microprocessor to find and to fetch the right instructions within the machine code address space, e.g. from within the instruction cache or from the main memory. Usually, instructions pertaining to the same thread have consecutive addresses. The first of said consecutive addresses is called the start address of said thread. E.g. if a thread contains 32 32-bit instructions (=32×4=128 bytes in total) and if the addresses of said instructions lie in the 128 byte range of 0x04000300 to 0x04000380, then the address 0x04000300 would be the start address. Furthermore, machine code usually contains branch instructions. Usually, branch instructions have one or two branch addresses, depending whether they are unconditional or conditional respectively. When a branch instruction is executed, then the microprocessor fetches instructions from the branch (or jump) address onwards. Each of said branch addresses indicates the address of the instruction to be fetched when said branch execution is executed. A branch path is the set of instructions fetched from a branch address onwards and are said to belong or to lie on that branch path.

Furthermore, said microprocessor may have several program counters such several branch instructions may be executed in parallel. In this case, instructions are fetched from different branch paths and one speaks of multi-PC microprocessors. Multi-PC microprocessors, e.g. multi-treaded microprocessors, are required if several threads shall be executed in parallel. These threads must then share in some way or another the available resources within the microprocessor, e.g. the ALUs, the FUs, the register files, the data caches etc . . . . Said threads may also correspond to regions of different source code programs. Often, said sharing of microprocessor resources among threads is controlled by a distinguished thread or superviser thread being part of the operating system.

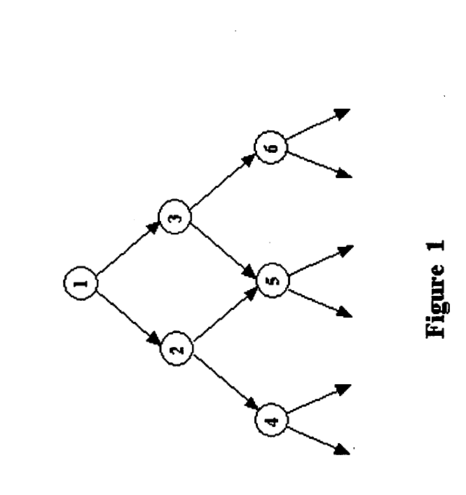

A special case of a thread or region is a branch path as defined above. A thread may also be a so-called basic block. A basic block is a branch path which includes the set of instructions which are fetched between the fetching and execution of two consecutive branch instructions, the first branch instruction excluded. In other words, a branch path is the set of instructions which are fetched from the branch address of a branch instruction onwards until the next branch instruction is fetched. E.g. if a branch instruction (denoted by) i0 is executed and if {i1, i2, i3, i4) denotes the (set of) instructions fetched from the branch address of instruction i0 onwards in the same order as indicated, then instruction i4 is a branch instruction and all other instructions of the set are not. The first branch instruction defines the so-called entry point (or entry address) into said basic block whereas the address of instruction i4 defines the so-called exit point of the basic block. Therefore, a basic block is a region or a thread with only one entry point and one exit point. A hyper-block is a region which has one entry point and several exit points. A hyper-block is often given in form of a directed acyclic graph (dag), also in form of an acyclic control data flow graph, where:
the nodes are basic blocks
the entry point is the node having an incoming edge emanating from a node of another region
the exit points are the nodes having an outgoing edge ending in a node of another region
the directed edges between the basic blocks represent the control flow as given by the branch instructions of each basic block; e.g. if a basic block (denoted by) ‘bb1’ has a directed edge towards two basic blocks ‘bb2’ and ‘bb3’, this means that the branch instruction of basic block ‘bb1’ branches either to (the first instruction) of basic block ‘bb2’ or to (the first instruction) of basic block ‘bb3’; FIG. 1. shows an example of a hyper-block given in form of a dag

Hyper-blocks are the smallest regions considered by many modern compilers and instruction scheduling algorithms, e.g. the ELCOR compiler from Hewlett Packard Labs.

As mentioned above, a region may be arbitrarily complex. E.g. it may be given in form of an arbitrarily complex cyclic control data flow graph having several entry points, exit points and cycles.

As usual, a branch instruction branches (or jumps) to that branch address (out one or more branch addresses) which is selected (or determined) by the branch condition. The branch condition is given by a value which may be stored:
in some dedicated register (status register, flag register etc.) of the microprocessor; in this case, the value stored in said dedicated register at that point in time when an branch instruction begins execution is taken to select the correct branch address
or in a predication register; in this case, one or more instructions of the instruction set may be predicated; in other words, the instruction format of those instructions contain a predication bit-field which specifies a predication register; a predicated instruction is only executed if the value stored in said predication register is set to a specific value (often logical value ‘0’ or logical value ‘1’)
or as the value of a symbolic variable stored in any memory location (address) of the memory hierarchy; in this case, instructions may also be predicated, however with the generalization that the predication bit-field may now also specify a symbolic variable; in that case, one says that said symbolic variable is specified as predication variable of a predicated instruction and said symbolic variable may play the same role as a predication register, with the difference however that its value may be stored anywhere in the memory hierarchy, not only in a predication register; the concept of a symbolic variable will be described in more detail in the next sections

Another important concept used in the context of the present invention is that of the lexicographical order of instructions in a machine code. Assume that a given machine code is partitioned into threads (or basic blocks). The lexicographical order may be defined as an upwards labeling of instructions within each thread of said machine code which guarantees for a correct execution of instructions within each thread. In other words, if all instructions within a thread are executed in the same order as indicated by their lexicographical order, then the thread is guaranteed to be executed in a correct way because all data dependencies between instructions of the thread are respected. E.g. if an instruction has lexicographical order (or label) 5, it means that this instruction must wait until all instructions with a smaller lexicographical order (less than 5) have been executed. Instructions having the same lexicographical order may be executed in parallel. The whole machine code is guaranteed to be executed in a correct way if depending threads are executed sequentially. In other words, if a branch instruction within a thread (denoted by) T1 branches to an instruction of another thread T2, then any instruction of thread T2 begins execution only after all instructions of thread T1 have been executed. Thread T1 is often denoted by caller thread and thread T2 by callee thread.

Although not found in this way in the literature, the notion of lexicographical order may also be applied unchanged to instruction operands and results specifying a same register or a same symbolic variable. In this case, each operand and result of each instruction gets assigned a lexicographical order (or label). E.g. assume that a result of an instruction i1 and an operand of an instruction i2 specify a same register R2 of a register file. If the instructions i1 and i2 have lexicographical order 5 and 10 respectively, then register R2 used as result of instruction i1 has lower lexicographical order than when it is used as operand of instruction i2. In other words, register R2 (or more precisely, the value stored in R2) shall only be used as (value of) operand in instruction i1 after it has been written as result in instruction I2. The same method applies if the operands and results specify symbolic variables instead of registers. The concept of symbolic variables will be defined in the next sections. It is clear that if the lexicographical order of operands and results of instructions is respected or preserved, than the lexicographical order of instructions is also preserved.

The lexicographical order of instructions, operands and results represents useful information for dynamically scheduled superscalar microprocessors which may dynamically reorder and execute instructions in a different order (e.g. out-of-order) as the lexicographical order. Usually, such a microprocessor has means to do predictions of the following kinds:
1. branch address prediction, in order to predict whether a jump or branch is taken or not, and where said prediction is known to the microprocessor a certain amount of time (given in clock cycles) before the actual jump or branch instruction is executed; in other words, when a branch or jump instruction is fetched and decoded, the microprocessor is able to predict whether that jump will be taken or not; the microprocessor may then continue to fetch, decode and execute instructions from the predicted branch or jump address onwards; instructions fetched from a predicted branch may be marked as ‘speculative’
2. value prediction of instruction operands/results, in order to overcome the data flow limit given by the data dependencies between instructions; instructions containing predicted (values of operands) may be executed speculatively and marked as ‘speculative’
3. load/store address predictions, in order to speculatively load or store data from the predicted load/store addresses; the data (values) loaded from or stored into predicted load/store addresses are marked as ‘speculative’; said load/store addresses may also refer to symbolic variables

Since the out-of-order (e.g. the non-lexicographical-order) and speculative execution of instructions may produce wrong results, said microprocessor must have means to identify the wrong instruction results, to (re-) execute instructions and to overwrite the wrong instruction results with the correct ones. In order to do so, it relies on lexicographical order information in order to find out:
the correct execution order of instructions, operands and results
if and when the operands and results of any instruction are valid or become valid

An operand or result of an instruction is valid if and only if:
1. the address (within the memory hierarchy) at which the value of said operand or result shall be stored or loaded from, is not marked as ‘speculative’
2. and the value of said operand or result is not marked as ‘speculative’, in other words after all data dependencies (e.g. RAW hazards) and all name dependencies (e.g. WAR and WAW hazards) with operands and/or results of other instructions are respected

In other words, if one of more of these two conditions are not satisfied and/or if the instruction itself is marked as ‘speculative’, the microprocessor may then speculatively execute said instruction and mark the result of said instruction as ‘speculative’. If a prediction of one or more of the previous kinds turns out to be false, the microprocessor may have means to flush only those instructions in the instruction pipeline and to re-execute only those instructions which are marked as ‘speculative’.

It is important to see that, if the lexicographical order of operands and results of instructions is respected, then all data dependencies and all name dependencies between instructions are respected.

On one hand, dynamically scheduled superscalar microprocessors with out-of-order instruction execution are often running sequential machine code which does not contain any lexicographical order information. This is not a contradiction, because in sequential machine code instructions are fetched in lexicographical order. The microprocessor may then himself dynamically generate all required lexicographical order information during instruction decoding and use this information to correct the wrong doings of speculative and/or out-of-order instruction execution.

On the other hand, if one explicitly inserts lexicographical order information into the machine code, then one has the advantage that a compiler may generate parallel (and out-of-order) machine code which may be executed faster, e.g. by using speculation, than sequential machine code. This is because the compiler has already re-ordered the instructions in the machine code offline in a more efficient way than could be done dynamically by using sequential machine code. This finally results in more instructions executed in parallel. In both cases, the microprocessor requires the lexicographical order information in order to (re-) execute instructions in the correct order such a way that wrong data (or wrong instruction results) generated by wrong speculative execution are overwritten with correct ones.

There are many possibilities to insert lexicographical order information into the machine code. A straightforward approach is to spend an additional bit-field in the instruction format which indicates the lexicographical order for one or more instruction operands and/or results.

Before closing this section, the attention is drawn to the fact that lexicographical order information is just one example of additional information which may be inserted into machine code, in addition to the machine code instructions themselves. In section 4., it will be shown that structured symbolic machine code contains a whole list of additional information which is inserted into symbolic machine code.

### 3. PRIOR ART

The concept of structured symbolic machine code plays a central role in the context of the present invention. Structured symbolic machine code is a special case of symbolic machine code. Therefore, its difference with prior art machine code shall now be described shortly. A more detailed description is given in section 4.

In prior art machine code, instruction operands and results usually refer to (or specify) one of the following:
1. a register of a register file of said microprocessor, where the content of said register is either a numeric value or an address; it the content is an address, this address specifies an address (memory location) within the memory hierarchy and this address may either hold a numeric value or still another address, and so on . . .
2. either a numeric value or an address and where said numeric value and said address are used as value for the operand or result during the execution of said instruction

Furthermore, indirect memory references in load/store instructions are often given in form of registers holding (or whose contents are) addresses and where said addresses refer to the memory locations where data have to be loaded from or stored to. E.g. ‘LD (R1)’ in assembler notation would refer to a load-instruction having an indirect memory reference in form of the memory address stored inside register R1.

Since microprocessors usually rely on register renaming during machine code execution, it usually happens that the register, where the value of an instruction operand is stored during machine code execution, is different from the register specified in the machine code for that same instruction operand. E.g. assume an instruction, being part of some machine code, which adds two numbers (values) together and is given in assembler notation like ‘ADD R1, R2, R3’ and where the instruction operands are specified by registers R1 and R2 holding the two numbers, and where register R3 specifies the location where the instruction result is stored. Then after register renaming, it may happen that, when said instruction is executed, said two numbers will be stored in registers R5 and R9 and the instruction result (the sum of the two numbers) stored in register R10. Therefore, one often speaks of symbolic registers appearing in the machine code, because register renaming dynamically re-maps (or allocates) the symbolic registers to the physical registers of the register file during machine code execution. However, first it Is Important to notice that a symbolic register is always re-mapped to a physical register and not to any other memory location within the memory hierarchy (the register file being part of the memory hierarchy). Second, it is important to see that register renaming does not change anything to the way in which instruction operands are specified in prior-art machine code.

In contrast to conventional machine code, in (structured) symbolic machine code, the bit-fields (within the instruction format) specifying the instruction operands and instruction results may refer to (or specify) symbolic variables. However, symbolic machine code may still contain instructions having operands and/or results specifying registers (or numeric values or addresses) as in prior-art machine code. Structured symbolic machine code is a special case of symbolic machine code and is further described in the next section.

From a high level programmers' point of view, a symbolic variable may be seen as a variable or an instance of a variable, including pointer variables, as declared in some program written in some programming language (e.g. C++, Fortran, Java etc.), e.g. a integer variable declared in C++by: int my_var. From a machine code point of view, a symbolic variable often represents a dedicated cache entry or look-up-table entry holding an address (or the memory location) within the memory hierarchy of a microprocessor where the value of said symbolic variable is stored.

Although Java Byte Code patented by Sun Microsystems may appear similar to structured symbolic machine code, it does not consider the concept of symbolic variables. First, the instruction format of instructions in Java Byte Code allows that instruction operands and/or results may be of so-called reference type, but it does not allow operands and/or results to specify symbolic variables. E.g. an instruction operand (op1) may be specified by an index (e.g. a symbolic reference) into the so-called constant pool table of a method or thread currently in execution and where said index specifies a value. Said value may then be used (maybe by other instructions) in order to determine the address where the value said operand (op1) is stored in the stack. In structured symbolic machine code as defined in the present invention however, the values of symbolic variables may be stored either in any register file of the microprocessor or anywhere in the heap. Second, Java Byte Code is the machine code executed by Java Virtual Machines which are stack machines and which do not possess a register file nor a complex multi-level memory system and memory hierarchy, as is the case for the data processing system considered in the present invention.

### 4. DESCRIPTION OF THE INVENTION AND PREFERRED EMBODIMENT

Before describing in more detail the concept of structured symbolic machine code, two important concepts are introduced and described first. Basically, these concepts are not new and may be found in the literature in one form or another. But, these concepts become especially interesting together with the concept of symbolic machine code and are part of structured symbolic machine code. One of the main aspects of the present invention consists in showing how this concepts are used by a microprocessor in order to execute structured symbolic machine code.

Since structured symbolic machine code is a special case of symbolic machine code, the concept of symbolic machine code and of symbolic variables is described first.

As mentioned before, in symbolic machine code, the bit-fields (within the instruction format) specifying the instruction operands and instruction results may refer to (or specify) symbolic variables. A symbolic variable is similar to a symbolic register holding an address, however with the fundamental difference that a symbolic variable does not specify a register within some register file of the microprocessor but one or more entries (or memory locations) in some dedicated memory other than the register file, and where each of said entries holds (or stores) Information (or a value) which is used to determine or to compute a so-called definition address. The definition address Is an address within the memory hierarchy where the value of said symbolic variable may be stored to and loaded from. In its simplest form, the information (or the value) stored in the entry (within said dedicated memory) specified by a symbolic variable is equal to the definition address of said symbolic variable. As for any memory, said entries are (or represent) addresses or memory locations within said dedicated memory. Furthermore, said dedicated memory may be of any kind and type but is not used as register file within said microprocessor. E.g. said dedicated memory may be a data cache, a look-up-table, a main memory, a hard disk, a non-volatile memory like EPROM-, EEPROM- or MRAM-memory etc . . . Because a symbolic variable is not a symbolic register, no re-mapping of symbolic variables is required during machine code execution, although a re-mapping may be done optionally.

In practice, a definition address may be seen as an address within the main memory as determined by the compiler during memory layout and machine code generation. The compiler tries to allocate each symbolic variable a unique definition address during machine code execution in order to avoid that valid data are overwritten, possibly resulting in an erroneous execution.

It is clear that said information, e.g. the definition addresses of said symbolic variables, which is has to be stored in the entries of said dedicated memory:
is either part of the symbolic machine code itself; in this case said microprocessor has to read in or to fetch, prior to the execution of instructions of which operands an/or results specify symbolic variables, said information from a memory (e.g. the instruction cache) where said symbolic machine code is stored and store said information into said dedicated memory
or is already stored in said dedicated memory prior to execution of said symbolic machine code

It should be noted that the above definition of a symbolic variable allows a symbolic variable to have several definition addresses.

As in the case of symbolic registers holding addresses, it is important to notice that the definition of a symbolic variable is recursive. In other words, the entry specified by a symbolic variable may hold (or store or point to) an preliminary address (or entry or memory location), this address holding yet another address which is used to determine another preliminary address and so on until the final definition address is known. E.g. if a symbolic variable specifies an 32-bit address (in hexadecimal format) 0x00000000, then this address may point to another address 0x00000020, address 0x00000020 may point to address 0x00000040 and address 0x00000040 finally holding (storing) a value of said symbolic variable. This recursion is comparable to the structure of a linked list where an element of the list points to the previous or to the next element in the list, and so on. Therefore, as will be shown shortly, symbolic variables naturally arise as the ‘machine code pendant’ of pointer variables declared In a program written in some high level programming language.

Furthermore, it is important to see that for symbolic variables referring to scalar variables, the definition address will be fixed during machine code. However, for symbolic variables referring to arrays and pointers, the definition address is usually computed by using the values of other symbolic variables. Therefore, the definition address may vary during machine code execution. E.g. in case of 2-dimensional array indexed by two indices, the values of these indices are used to calculate the definition address of that array (see below for a concrete example). Finally, the definition address of a symbolic variable may still be added to some offset to get the address within the memory hierarchy where the value of said symbolic variable is finally to be stored to or loaded from.

Although the difference in the definition between a symbolic register and symbolic variable may appear minor, a symbolic variable has a totally different meaning than a symbolic register and this has dramatic consequences. First, at one hand a symbolic variable is a strong generalization of a symbolic register in the way that, after definition address re-mapping, a symbolic variable may have its value stored anywhere in the memory hierarchy, and not only in some register file. Second, because in practice a symbolic variable will normally refer to a variable declared and defined in some program written in some high-level programming language (e.g. C++), it allows compilers to generate symbolic machine code from a said program in a totally new way. Third, since by definition symbolic variables make a symbolic link to memory addresses, it is possible to generate symbolic machine code which contains no explicit load/store instructions because symbolic variables contain all the information required by said microprocessor in order to determine where in the memory hierarchy it will find and store values of symbolic variables (see below for a concrete example).

First, a short example shall further clarify the concept of a symbolic variable. Assume that some instruction within some symbolic machine code has an instruction format where a 3-bit wide bit-field with the binary value of ‘001’ specifies an instruction operand for that instruction. Then, the binary value (number) given by ‘001’ does not refer to a specific register out of 8 possible registers of some register file nor to an address within the memory hierarchy used as operand value for that instruction, but to symbolic variable ‘001’, e.g. to a specific address out of 8 possible addresses within some dedicated cache or within the memory hierarchy, and where the content (or value) stored at this specific address is not used as operand value for that instruction, but is an address (e.g. a 32-bit address 0x00004021) holding the value (e.g. the decimal value 35) of said symbolic variable. This value is then finally used as operand value for that instruction, and where said operand is specified by the symbolic variable given in form of the binary value ‘001’.

As mentioned already in section 3, from a high level programmers' point of view, in many cases a symbolic variable corresponds to a variable or to an instance of a variable, including pointer variables, as declared in some program written in some high-level programming language (e.g. C++, Fortran, Java etc.). From a machine code point of view, a symbolic variable often represents a dedicated cache entry or look-up-table entry holding the definition address (in other words the memory location) within the memory hierarchy of said microprocessor where the value of said symbolic variable is stored.

In the following, the term ‘definition address’ will simply be replaced by the term ‘address’ if no ambiguities or misinterpretations are possible.

The example below of a C source program shall illustrate how symbolic machine code is looking like in practice and how the microprocessor relies on symbolic variables within symbolic machine code in order to determine when and where in the memory system and memory hierarchy said data have to be loaded from and stored to.

To this end, we consider the following C source program, where 3 integer variables i, b and c[20] are declared, and which contains a for-loop containing a conditional if-then-else statement, several assignments and expressions involving a scalar variable b and an indexed (array) variable c . The variable i represents the loop index and counts the iterations. For ease of description, the program lines are labeled upwards from 0 to 4.

0 int i, b, c[20];
1 for (i=0 ; i ≦ 19 ; i++) {
2 b=b+c[i] ;
3 if (b ≦ 1) then { c[2*i]=c[i+1] ; }
4 else { c[2*i]=c[i ] ; }}

A symbolic machine code version of the above program is obtained by transforming the declared variables into symbolic variables used later in the symbolic machine code. To this end, one does first a symbolic labeling of the declared variables i, b, c[2001]. E.g. one can label variable i by v0, variable b by v1, instance c[2*i] by v2, instance c[i+1] by v3, and instance c[i] by v4. These 5 consecutive labels will correspond to 5 symbolic variables in the symbolic machine code. These 5 symbolic variables can be encoded by 3 bits in 3-bit wide bit-fields for operands and results of those instructions in the C source program which use these labels as operands and/or as results. E.g., an operand bit-field of ‘000’ would correspond to variable v0, ‘001’ to variable v1, ‘010’ to variable v2, ‘011’ to variable v3, ‘100’ to variable v4.

According to the definition of a symbolic variable, when the microprocessor fetches and decodes an instruction which has f. ex. v1 specified as operand or result, then
1. the microprocessor accesses the entry ‘001’ within some memory as specified by ‘v1’
2. retrieves the address 0x00000000 stored at this entry
3. uses address 0x00000000 to load the value of said symbolic variable as operand value of said instruction.

In a straightforward approach, each symbolic variable points to an address within the memory hierarchy. In case of the scalar variables i and b, this address is equal to the definition address where their values are stored. In case of an instance of the array variable c, this (base) address is added to an offset in order to get the (definition) address where the value of that instance is stored. E.g., using C++ syntax, in case of the instance c[2*i] of variable c, the offset would be equal to 2*10=20 for i=10 and the address holding the value of c[20] would be equal to definition address=base_address+offset. In case of a pointer variable *p, the symbolic variable points to the address given by p, where (e.g. according to C++ syntax of pointer arithmetic) this address is equal to the definition address and may be determined by evaluation of an arithmetic expression involving other declared variables (also pointers) and where the value *p is stored at the address given by p. Similarly for multi-level pointer variables which may be equivalently described by several simple pointer variables. E.g. in case of a declared two-level pointer *(*p) within C++, one declares instead two pointer variables *p1, *p2 of the same type and one replaces all occurrences of *(*p) by *p2, and all occurrences of *p and p by *p1 and p1 respectively. In this way, the program contains only simple pointer variables which may each be referred to by a separate symbolic variable. Therefore, is important to see that the definition addresses of array variables and pointers may vary during machine code execution.

However, it is important to notice that the definition of symbolic variables is independent of the way in which symbolic variables are generated, labeled and encoded in the symbolic machine code. E.g. in case of the indexed variable c, one may spend a different symbolic variable for each instance of that variable (as was done above with the symbolic variables v2, v3, v4 for the instances c[2*i], c[i+1] and c[i]) or just one common symbolic variable for all instances or any mixture thereof. Furthermore, in case or more complex programs, it will usually happen that additional symbolic variables, other than those declared and defined in the program, have to be spent in order to map complex expressions and statements onto the set of instructions of said microprocessor. E.g., if a C source program contains an expression involving the division of two numbers and if the microprocessor has no dedicated instruction for performing a division directly, then the division has to be realized by a set of more simple arithmetic instructions known by the microprocessor. E.g. if a Newton-Raphson scheme is used to implement a division, then this involves arithmetic instructions like addition, subtraction and multiplication. Within that scheme, each of these more simple arithmetic instructions will produce intermediate results used by subsequent instructions, until the final division result is obtained after a few iterations. Therefore, for each of these intermediate results, the compiler (or the manual writer) may have to spend an additional symbolic variable.

For the following symbolic machine code corresponding to the above C source program, a symbolic variable is spent for each declared scalar instance (e.g. variable i and b) and for each instance of the array variable c. Furthermore, two additional symbolic variables v5 and v6 have been spent to store intermediate instruction results of code lines 5 and 6.

```
0 ADDR v0,0x00000000; ADDR v1,0x00000002; ADDR v2,0x00000008;
  ADDR v3,0x00000008; ADDR v4,0x00000008; ADDR v5,0x00000008;
  ADDR v6,0x00000008; LDC v0,#0; OFFSET
  v4,v0; OFFSET v2,v5 ; OFFSET v3,v6
1 ADD v1,v4,v1
2 CMP #1,v1
3 JLT #6
4 SHTL v5,#1,v0 ; INC v6,v1
5 TFR v2,v3 ; JMP #7
6 TFR v2,v4
7 BLTINC v0,#1,#20
```

The code lines are labeled upwards for illustration purposes. Instructions in the same code line are separated by semi-colons (;). Instruction arguments are separated by colons (,). Constant arguments are marked with a ‘#’-sign followed by the decimal value of the constant. The mnemonics for each instruction are given in uppercase letters.

First, in line 0, a definition address is defined for each symbolic variable referring to a declared scalar variable in the C source program and a base address is defined for each instance of the declared array variable c. E.g. the instruction ADDR v0,0x00000000 assigns the 32-bit hexadecimal address 0x00000000 as definition address to the symbolic variable v0. In other words when the microprocessor fetches and decodes an instruction which has v0 as operand or result, then
4. the microprocessor accesses some entry (address) within some memory as specified by ‘v0’, e.g. entry 001 out of 8 possible entries
5. retrieves the address 0x00000000 stored at this entry
6. uses address 0x00000000 to load the value of said symbolic variable as operand value of said instruction

Furthermore, line 0 determines the offsets (e.g. v0, v5, v6) which have to be added to the base addresses of the symbolic variables (e.g. v4, v2, v3) referring to the instances of the array variable c in order to get the definition addresses where the values of said instances are stored. E.g. OFFSET v4, v0 adds the offset given by the value of symbolic variable v0 to the base address of symbolic variable v4.

Line 1 corresponds to line 2 of the C source program. Line 2 corresponds to the comparison ‘b<=1’ in line 3 of the C source program. Line 4 computes the offsets of symbolic variables v2, v3 in form of the symbolic variables v5 and v6. Lines 5 and 6 perform the assignments of line 3 and 4 of the C source program. Line 7 increments the iteration counter (symbolic variable v0) and branches back to code line 1 in order to execute the next iteration.

The computation of the definition addresses of symbolic variables, e.g. the computation of address offsets of symbolic variables referring to instances of array variables (see above for concrete examples), may require the execution of a more or less large portion of machine code containing several instructions. This means that said addresses are finally given (or computed) in form of instruction results which yield the addresses of said symbolic variables. However, this means that in general these instruction results hold definition addresses which refer to other symbolic variables than those specified by the instruction results themselves. In other words, a definition address being the value of a symbolic variable specified by an instruction result may not be the definition address of that same symbolic variable, but of another one. E.g. assume that the value of a symbolic variable (denoted by) v1 is a (32-bit) definition address 0x04003020. This definition address may well be the definition address of another symbolic variable v2. Therefore, it is useful to define instructions in the instruction set of said microprocessor which make the link between symbolic variables and their definition addresses. These instructions, which make a link between definition addresses and symbolic variables, are called symbolic link instructions in the following.

An short example shall clarify the concept of symbolic link instructions. E.g., assume that we want to compute the definition address of a symbolic variable s1 and that, after execution of some instructions, the result of the last executed instruction yields the definition address of symbolic variable s1 but specifies another symbolic variable s2. Then a symbolic link instruction specifies these two variables s1 and s2 as its operands and makes a symbolic link between them. After decoding and executing such an instruction, the microprocessor knows that:
the value of symbolic variable s2 is used in the further computation of the definition address of symbolic variable s1 or
that the value of symbolic variable s2 is equal to the definition address of symbolic variable s1

Symbolic variable s2 is called the ‘address variable’ of (or associated with) symbolic variable s1.

An example of symbolic link instruction is the ‘OFFSET’ instruction used in the above symbolic machine code.

A symbolic link instruction may also:
be given in form of an implicit instruction having one or more operands
maybe part of a more complex (and maybe implicit) instruction; in other words, the execution of said complex instruction perforns, among other data operations, the same data operations as the symbolic link instruction taken alone
maybe part of general information associated with symbolic variables within symbolic machine code, and where said information maybe given in form of a specific data structure like a list, a tree etc . . . (see the information associated with each region of structured symbolic machine code for details)

E.g., a symbolic link instruction may be part of an instruction which, among other data operations, assigns definition addresses to symbolic variables and stores them into said heap-address cache. E.g. a symbolic instruction could be part an ‘ADDR 0x00006700,v0,v1’ instruction, which:
assigns definition address 0x00006700 to symbolic variable v0
makes the link between symbolic variables v0 and v1, indicating to the microprocessor that the value of symbolic variable v0 is used in the computation of or is equal to the definition address of v1

As mentioned above, these kind of instructions may have to be fetched by the microprocessor prior to execution of instructions having operands specifying said symbolic variables.

Another important concept relying on the concept of symbolic variables is that of a data dependence variable. There are three types of data dependence variables:
RAW (read-after-write) data dependence variables
WAR (write-after-read) data dependence variables
WAW (write-after-write) data dependence variables

Given a symbolic machine code. A RAW data dependence variable is defined to be a symbolic variable which satisfies the following conditions:
said symbolic variable is specified as operand of an instruction and as result of another instruction of said machine code
the value of said instruction operand is valid if and only if the value of said instruction result is valid

Hence, two lexicographical orders may be associated with this symbolic variable, depending on whether said variable is specified (or used) as instruction operand or as instruction result. The lexicographical order associated with this symbolic variable when used as instruction result is called the RAW-lexicographical order of that symbolic variable. In other words, the RAW-lexicographical order of a symbolic variable gives the lexicographical order of said instruction result which determines when (the value of) said instruction operand is valid. The above definition is equivalent to saying that the value of said instruction operand is valid (e.g. it may be Read from some memory location) only if and After the value of said instruction result is valid (e.g. after it has been Written into some memory location).

A WAR data dependence variable is defined to be a symbolic variable which satisfies the following conditions:
said symbolic variable is specified as operand of an instruction and as result of another instruction of said machine code
the value of said instruction result is valid if and only if the value of said instruction operand is valid

Hence, two lexicographical orders may be associated with this symbolic variable, depending on whether said variable is specified (or used) as instruction operand or as instruction result. The lexicographical order associated with this symbolic variable when used as instruction operand is called the WAR-lexicographical order of that symbolic variable. In other words, the WAR-lexicographical order of a symbolic variable gives the lexicographical order of said instruction operand which determines when (the value of) said instruction result is valid. The above definition is equivalent to saying that the value of said instruction result is valid (e.g. it may be Written into some memory location) only if and After the value of said instruction operand is valid (e.g. after it has been Read from some memory location).

A WAW data dependence variable is defined to be a symbolic variable which satisfies the following conditions:
said symbolic variable is specified as result of an instruction and as result of another instruction of said machine code
the value of one of said instruction results is valid if and only if the value of the other one of said instruction results is valid

Hence, two lexicographical orders may be associated with this symbolic variable, depending on for which instruction said variable is specified (or used) as instruction result. The lexicographical order associated with this symbolic variable specified as instruction result is called the RAW-lexicographical order of said symbolic variable. In other words, the WAW-lexicographical order of a symbolic variable gives the lexicographical order of said instruction operand which determines when (the value of one of said instruction results is valid. The above definition is equivalent to saying that the value of one of said instruction results is valid (e.g. it may be Written into some memory location) only if and After the value of the other one of said instruction results is valid (e.g. after it has been Written from some memory location).

If a symbolic variable is used as instruction operand or written as instruction result for the first time during execution of a machine code, then this symbolic variable does not have any data and name dependence, hence no RAW, WAR or WAW data dependence variable.

Since a symbolic variable may be specified as operands and/or results of instructions laying on different branch paths of a machine code, its RAW-, WAR- and WAW-lexicographical order maybe different from branch path to branch path. E.g. this is the case of a symbolic variable which is specified:
as operand of a first instruction and as result of a second instruction, both instructions lying on a first branch path and where the RAW-lexicographical order of this variable on this first branch path is 2
as operand of a first instruction and as result of a second instruction, both instructions lying on a second branch path and where the RAW-lexicographical order of this variable on this second branch path is 4

As for lexicographical order information in general, all three types of data dependence variables may be used by an out-of-order execution microprocessor to re-arrange and (re-)execute instructions in a correct way when miss-predictions occur.

Another important concept is that of a dependence group of a symbolic variable. Given a symbolic machine code. The dependence group of a symbolic variable is defined to be the set of symbolic variables which may have the same definition address as said symbolic variable. It is recalled that a symbolic variable may refer to:
a symbolic constant,
e.g. a constant named ‘my_cst’ and declared as:
const int my_cst=10;
or as:
#define my_cst 10;
in a C-source code program
a scalar variable
an instance of an (multidimensional) array variable
a pointer variable as declared in a source code program written in some high level programming language. Whereas the definition address of a scalar variable is assigned by the compiler during machine code generation (e.g. during compilation) and is usually fixed and does not change during execution of said machine code, the definition addresses (e.g. the offsets) of array variables and of pointer variables do change and may interfere and collide.

A short example shall illustrate the concept of dependence group. Assume a source code program written in C containing:
two integer variables declared as int j1, j2;
two instances a[2*j+1] and a[j] of an array variable declared as int a[100];
a pointer variable declared as int *p;

If, during symbolic machine code generation, a compiler spends a separate symbolic variable s1 and s2 for each of the two instances a[2*j+1] and a[j] and a separate symbolic variable s3 for the pointer variable p (compare with the symbolic machine code generation of the above C-source program) then the dependence group of symbolic variable s1 would equal to {s2,s3), that of s2 equal to {s1,s3} and that of s3 equal to {s1,s2}. This is because the definition addresses of s1, s2 and s3 maybe identical. E.g. for j2=1, j2=5 and p=&a[5], the value *p would be stored at the same address as the value of instance a[2*j1+1]=a[5] and the value of a[j2]=a[5]. Therefore, instances belonging to dependence group may have identical definition addresses and may have to be disambiguated dynamically during machine code execution. It is recalled that definition addresses of instances of pointers and arrays may change during machine code execution. From the definition of a dependence group of a symbolic variable, it is clear that a symbolic variable may pertain to several dependence groups and that the definition addresses of scalar instances may well interfere and collide with those of arrays and pointers. Furthermore, if a symbolic variable is specified as operand of an instruction and belongs to a non-empty dependence group, then this symbolic variable is said to be data dependent.

Another important concept in the context of the present invention is that of a branch tree associated with a region. A branch tree has a tree data structure. A tree data structure is usually a (maybe linked) list, where each element (or node) of the list has one or more leafs (or successor nodes) and where each of said nodes may be itself a data structure containing specific information or having specific attributes.

A minimal set of information (or attributes) is associated with each node (N1) of a branch tree and which specifies:
an identifier (or label) associated with said node (N1)
maybe (the label of) a symbolic variable which is used as a predication variable of an (predicated) instruction of said region
(the label of) one or more successor nodes

If each node has only one predication variable associated with it, said predication variable may also be used as node identifier (e.g. to index the branch tree). A node having successor nodes is also called a predecessor node of said successor nodes. A node may have none, one or more predecessor nodes.

E.g. if a predication variable can take two values, then each value may specify one of two possible successor nodes.

In practice, a branch tree has the purpose to allow the microprocessor to reconstruct all possible branch paths inside a region and to do (maybe speculative) branch prediction. E.g. if some node (a) is successor node of some node (b) and node (b) is successor node of some node (c), then there exists a (directed) branch path from node (c) to node (a).

In addition to the above information, each node (1) of a branch tree may have (or store) additional information associated with it and specifying:
a branch address associated with said node (1)
the number of instructions associated with said node (1); e.g. if a basic block is associated to said node (1) (see the example of a hyper-block below) then the number of instructions associated to said node (1) are the instructions pertaining to said basic block
and/or a branch address associated with each successor node of said node (1)
and/or none, one or more branch counts associated with said node (1), where each of said branch counts stores a specific value used to perform error corrections relative to speculative branch prediction defined further below
a branch flag associated with said node (1), where said branch flag indicates whether there is just one successor node of said node (1) or not ; e.g. when said branch flag is set to ‘1’, it may indicate to the microprocessor that it may do an unconditional jump to the branch address associated to the successor node of said node (1) and when said branch flag is set to ‘0’, it may indicate a conditional jump to the branch address of one of the successor nodes of said node (1).
a branch-back-flag associated to a successor node of said node (1), where said branch-back-flag indicates whether the following two conditions are satisfied or not:
   1. said successor node belongs to the same region as said node (1)
   2. there exists a branch path through the region from said successor node to said node (1)
a region-flag associated to a successor node of said node (1), where said region-flag indicates whether said successor node belongs to the same region than said node (1) or not
a function-flag associated to a successor node of said node (1), where said function-flag indicates whether the following two conditions are satisfied or not:
   1. said successor node belongs to another region (rx) than said node (1)
   2. said region (rx) contains machine code which is associated to the source code of a function declaration or definition; it is clear that this assumes that some source code of said function is available and may be compiled in order to generate said machine code
an exit-flag associated to a successor node of said node (1), where said exit-flag indicates whether the following two conditions are satisfied or not:
   1. said successor node belongs to another region than said node (1)
   2. the branch address associated to said successor node is not known statically before runtime and may be determined dynamically by the microprocessor during machine code execution; e.g. this may correspond to a branch address given by a pointer to a function or given by the return address of a function call

In case of a region being a hyper-block, the branch tree associated with a hyper-block has as many nodes as there are basic blocks in the hyper-block, where:
to each node (Na) corresponds exactly one basic block and vice versa
to each node (Na) corresponds exactly one predication variable (Pa) and vice versa; e.g. the value of predication variable (Pa) determines whether the branch to the basic block corresponding to node (Na) is taken or not; the value of predication variable (Pa) may be predicted;
the branch address associated with a node of the tree corresponds to the entry point of a basic block

Since a region may only be a part of the whole machine code, successor nodes of nodes belonging to a given region may not belong to said region but to another region. In this case, said successor nodes must be marked as such by a special label or flag. The microprocessor uses the branch addresses associated with each successor node to make the link with (e.g. to jump to) the next region. The branch address taken by a branch instruction is determined (or selected) by the (maybe predicted) value of a predication variable and is called the branch outcome of said branch instruction. A resolved branch outcome is either a correctly taken or a correctly predicted branch address.

Furthermore, a predication variable associated with a successor node is said to be dependent on a predication variable associated with a predecessor node if and only if, for some value (V11) of said predication variable, the node selected by said value (V11) is different from said successor node. Analogously for branch outcomes. Since the (values of) predication variables determine the branch outcomes, a branch outcome associated with a node is said to be dependent on a branch outcome associated with a predecessor node of said node. Furthermore, a predication variable which determines the outcome of a branch is said to be associated with that branch and vice versa. Hence predicting the value of a predication variable is equivalent in predicting the outcome of the branch associated with that predication variable.

The concept of predecessor node and dependent predication variables remain unchanged between regions. In other words, when a successor node is node belonging to another region, then a predication variable associated with said node is dependent on each predication variable of a predecessor node, even if this predecessor node belongs to another region.

A concrete example shall now illustrate the concept of a branch tree. To this end, the structure of the branch tree and the data structure of each node must be specified. In this example, the Backus-Naur-Formalism is used to define the syntax and semantics of the branch tree and of the data structure which holds the information associated with each node as follows:

branch tree: node branch tree node

node: predication_variable, branch_count, successor_predication_variable1, successor_predication_variable 2, branch_address1, branch_address2,

As mentioned before, in this example each node is uniquely identified by its predication variable (e.g. predication_variable). The value of the predication variable is either 0 or 1. Each node stores also the above mentioned branch count (e.g. branch_count) being usually an integer value, two possible successor nodes identified (or specified) by their predication variables (e.g. successor_predication_variable1, successor_predication_variable2) and two branch addresses (e.g. branch_address1, branch_address2) associated with each successor node.

In case that the region is a hyper-block, each successor node corresponds to a basic block and each branch address to the entry point of said basic block. Branch addresses may be specified:
by their values (usually a hexadecimal value) or
by a label which may specify an entry (or address) of a dedicate memory which stores the values of branch addresses (e.g. a branch target cache); e.g. a 7-bit label with decimal value 3 (=0000011 in binary format) would specify the 3^{rd} address (out of 2⁷=128 addresses) of a branch target cache and where said address stores the 32-bit branch address 0x54003801

Since predication variables may be symbolic variables, they may be specified by integer labels as well. E.g. if a hyper-block contains 32 symbolic variables (predication variables included), then 5-bit labels are enough to identify (or encode) each of the 32 variables. A variable with label ‘00101’ would mean the 5^{th} variable (00101_{bin}=5_{dec}) out of the 32 variables.

Using the above syntax and semantics, the branch tree associated with the hyper-block shown in FIG. 1 would be specified as follows:

1,3,2,3,0x09003010,0x09004010,

2,2,4,5,0x08002010,0x09003210,

3,1,5,6,0x07001010,0x09000010,

4,3,0,0,0x49000410,0x09504010,

5,3,0,0,0x09009010,0x09700510,

6,2,0,0,0x09003006,0x09020010,

In this example, each line specifies a node of the hyper-block (in total 6 nodes; see FIG. 1 for details). Each node is specified by an integer label ranging between 0 to 6. Successor nodes not belonging to said hyper-block have label 0. The branch counts of each node are given in form of an integer value as well. The branch addresses are given in hexadecimal format (32-bit).

If a region contains no branches, then it contains at least one basic block and in this case the branch tree degenerates either to an empty list or to a list having just one node. This node would usually have just one successor node and one branch address.

As for lexicographical order information, a branch tree structure represent additional information associated with a region and may be part of the symbolic machine code corresponding to a region. When lexicographical order information and branch tree information is fetched and decoded by the microprocessor, it may be stored in one or more dedicated memories internally within the microprocessor and accessed when required for doing instruction scheduling, (re-)ordering and (re-)execution. In particular, the branch addresses specified in a branch tree associated with a region may be stored in a branch target cache. Furthermore, the branch addresses specified in a branch tree may be given in numerous ways. E.g. in the most general case, the branch address specified in a branch tree may be information which is used by the microprocessor to calculate or to determine the actual branch address. In particular, a branch address specified in a branch tree may be may be an offset which has to be added to a program counter (PC) in order to get the address of an instruction within the machine code address space.

As mentioned above, a branch count may be stored in (the data structure of) each node of a branch tree. The meaning of this branch count shall now be further specified. The goal is to use this branch count to perform speculative branch prediction. Speculative branch prediction is a new concept not found in the literature and is part of the present invention. It is especially interesting in combination with structured symbolic machine code, and in particular with the branch information stored in a branch tree structure of a region. Although branch prediction is by definition a special case of data speculation and value prediction, speculative branch prediction goes one step further. Prior-art branch prediction, whether one-level, two level or hybrid branch prediction, relies on multi-level branch history of the most recently executed branches in order to make predictions. The first level of the branch history usually stores the outcomes of the most recently executed branches within branch history registers (BHRs) forming a shift register, or within a dedicated cache e.g. a branch history table (BHT) cache. This first level of branch history is then used, often together with a branch address, to index a second level of branch history often stored in a pattern history table (PHT) cache. This is often done by ‘XORing’ a lower portion of a predicted branch address with a branch history containing the outcome of the last executed branches. Using only part (often the lower 14 to 18 bits) of a predicted branch address to access the PHT leads to aliasing pressure of the PHT. In other words, the outcomes of uncorrelated branches may be written into the same entry of the PHT, thus diminishing the accuracy of the branch prediction. Each entry of the PHT usually stores the values (or the counter states) of one or more 2-bit saturating counters. The counter states of the entry selected (or accessed) are then used to determine whether a branch will be taken or not. Furthermore, as soon as the branches resolve the counter states stored in each entry of the PHT are updated (e.g. incremented or decremented) depending on the branch outcomes. E.g. a branch taken/not taken may increment/decrement the counter states of the PHT entries used in the prediction of that branch.

As mentioned before, in prior-art branch prediction, the first and second level of branch history only stores information about the outcome of resolved branch outcomes and only resolved branch outcomes are used to make predictions. In contrast, in speculative branch prediction, the branch history may store unresolved branch outcomes, e.g. outcomes of branches which are not yet resolved at the point in time when the prediction of a predication variable is being made. Concerning the second level of branch history, e.g. the PHT, it means that any counter state stored within the PHT may be updated by predicted but still unresolved branch outcomes. However, it is not relevant for the scope of the present invention if an unresolved counter update triggered by an unresolved branch outcome is first stored in a separate memory until and only written into the PHT when said branch has resolved. Because the branch history contains information about unresolved branch outcomes, one speaks of speculative branch history. In this case, as for speculative and out-of-order instruction execution, speculative branch prediction may lead to wrong data (of miss-predicted branch outcomes) stored in the branch history.

Therefore, the microprocessor must have means to find out which branch predictions were done using speculative branch history and which ones were not in order to perform the required corrections within each level of the branch history. The corrections in the first level of the branch history are easily done by flushing those BHRs containing speculative data. The corrections in the second level of the branch history consist in updating the branch counters in these tables with correct values when branch miss-predictions occur. More specifically, when (the value of) a predication variable is miss-predicted, the wrong branch address is taken and all predictions of dependent branch outcomes will be wrong as well. The branch count stored in each node of a branch tree has exactly the purpose to provide the information required to do a correct updating of these branch counters after miss-predictions have occurred. More specifically, a branch count associated with a node of a branch tree stores the counter state of a (maybe saturating) counter (stored in an entry) of the PHT at the point in time when or before the prediction of the value of a predication variable associated with said node shall start or shall be done and where said counter state is used in order to do the prediction of said value. In other words, at the point in time when the prediction of the value of said predication variable begins and is based on a counter state of the PHT, then said counter state has not (or cannot) yet been modified by the outcome of the branch associated with said predication variable.

Said branch count can now be used in different ways in order to do the before mentioned corrections in the PHT. One possible way is as follows : when a branch miss-prediction of (the value) of a predication variable occurs, then all dependent branch outcomes and the values of all dependent predication variables which have been predicted so far are wrong. This means that the unresolved counter updates in the PHT triggered by these dependent branch outcomes are wrong and have to be overwritten with the values of the counter states just before these updates were done. This is exactly what is achieved by overwriting the counter states with the branch counts stored in each node of a branch tree. Since each node corresponds to a predication variable, each of said branch counts corresponds to a counter state in the PHT which was used in the prediction of the (value of) the above predication variable and of any dependent predication variable thereof. In the following, the terms ‘counter state’ and ‘counter value’ are used synonymously. The counter state stored in a PHT entry may overwritten with the correct value as soon as the miss-prediction occurs or at a later point in time when said entry shall be used again for the prediction of another branch outcome. In the latter case, it is clear that the correct values (e.g. the branch counts stored in a branch tree) have to be stored in some memory until they are used for overwriting.

A short example shall illustrate the correction actions involved when a miss-prediction within a series of dependent branches occurs. To this end, consider again the above branch tree structure corresponding to the hyper-block shown in FIG. 1. Assume that:
(the branch of basic block 1 is predicted to branch to (the entry point of) basic block 2 and that the counter state used in the prediction of that branch is 2; this value is taken as value of the branch count (to be stored in the data structure) of node 1 of the branch tree
based on the predicted branch from basic block 2 to basic block 4, said counter state (or counter value) is decremented to 1
based upon this first prediction, (the dependent branch of) basic block 2 is predicted to branch to (the entry point of) basic block 4 and that the counter state used in the prediction of that branch was 1; this value is taken as value of the branch count (to be stored in the data structure) of node 2 of the branch tree
based on the predicted branch from basic block 2 to basic block 4, the counter state used in the prediction of that branch is incremented (updated) from 1 to 2

If, at some later point in time, the predicted branch from basic block 1 to basic block 2 turns out to be wrong, then the predicted branch from basic block 1 to basic block 2 is also obsolete (because never taken). Assume that, based on that miss-prediction, the predicted branch path is now instead from basic block 1 to basic block 3 and from basic block 3 to basic block 4. Assume furthermore that, due to the aliasing problem of the PHT, the predicted branch from basic block 2 to basic block 4 is based on and updates (the counter state of) the same PHT entry than the predicted branch from basic block 3 to basic block 5. If the counter state of that PHT entry would not be restored (or overwritten) with the original value of 2, this value being stored in the branch count of the node corresponding to basic block 2, then the prediction which decides whether the branch path will be from basic block 3 to basic block 5 or to basic block 6 would be based on a wrong counter state, namely on a counter state of 2 instead of 1. This would eventually lead to an incorrectly predicted branch from basic block 3 to basic block 6.

Therefore, in order to overwrite the wrong counter states stored in the PHT with the correct ones following the miss-prediction of the branch from basic block 1 to basic block 2:
the counter state of node 1 has to be restored with the original value of 2
the counter state of node 2 has to be restored with the original value of 1

As becomes clear from the example, the main purpose of speculative branch prediction is to do branch prediction along a branch path containing several dependent branches in the shortest time possible (in only a few clock cycles), without having to wait for branches to resolve. This is a key issue which allows to apply region scheduling in practice, e.g. treegion scheduling, where machine code must be fetched and speculatively executed from the trace (=a region) having highest probability or confidence among several traces. This allows to use the computation resources (=the FUs) of the microprocessor in the most efficient way.

As indicated by the definition of a branch tree, said branch counts may not be part of (or stored in) the information associated with a node of a branch tree itself. In this case, said branch counts may generated dynamically, e.g. they may be read out from the PHT during machine code execution when a specific branch prediction is being made and are stored in some dedicated memory or cache for later retrieval in order to overwrite wrong counter states in the PHT. Such a dedicated cache could be indexed with the labels (identifiers) of the nodes of the branch tree of the region currently being executed, such that the microprocessor can make the link between the predication variables used as branch tree nodes and the branch counts associated with each node. Hence, if a specific predication variable is miss-predicted, the microprocessor is able to determine where the branch count associated with that predication variable is stored such that it may restore the correct counter state within the PHT.

As mentioned above, structured symbolic machine code is a special case of symbolic machine code. More specifically, structured symbolic machine code contains one or more regions (or threads), where at least one (R1) of said regions contains symbolic machine code and where this symbolic machine code contains information associated with a symbolic variable link table (Ta) and/or a constant link table (Tb) and information associated with one or more of the following tables:
a branch tree (e.g. a branch tree table) (Tc)
a trace start address table (Td)
a pointer link table (Te)

It is important to see that the term ‘table’ does not restrict in any way the scope of the present invention, nor the way In which the above Information Is stored within structured symbolic machine code. The term ‘table’ is very general and may refer to a data structure which stores specific information. A table may also be seen as a mapping which associates table entries with information stored within these entries. In other words a table allows to make an association (or a link) between a table entry and the information stored within that entry. E.g. a table may be a one- or more-dimensional list, a single- or double-linked list, a tree etc . . . or any mixture thereof. E.g. a branch tree associated with a region may be defined as a table (T4). Each node of a branch tree can be associated with exactly one entry of table (T4) and voice versa and the information associated with a node is then stored in the entry associated with said node.

So called index information is required to specify (or identify) an entry among all possible entries of a table. Index information is often given in form of identifiers or labels and a table is said to be indexed by said labels. E.g. a list of 16 integer numbers may be stored in a table (T5) having 16 entries, each entry storing one of said integer numbers. Each of these 16 entries can be uniquely specified with a 4-bit value (or label). E.g. the label 0000 could specify entry 0, label 0001 could specify entry 1 etc . . . In other words, table (T5) is indexed by 4-bit labels, each 4-bit label specifying exactly one out of 16 entries. Hence, each integer number is stored in and associated with exactly one entry, this entry having a specific label. In other words, if one knows the label (L1) of the entry where an integer number (N1) is stored, one is able to retrieve (the value of) that integer number (N1). In the following, the terms ‘label’ and ‘identifier’ are used synonymously.

It is important to see that index information may be part of the information associated with a table. E.g. table (t5) having 16 entries can be specified by indicating the value stored within each entry:

| Entry | Value |
|---|---|
| 0 | 345 |
| 1 | 21 |
| 2 | 892 |
| . | |
| . | |
| . | |
| 15 | 67 |

If such a table is part of structured symbolic machine code, then the index information (e.g. the labels of the entries) may be provided in order to completely specify table (t5). E.g. this could be done by listing all the entry labels followed by a list of the values stored in each entry: 0, 1, 2, . . . , 15, 345, 21, 892, . . . 67. However, when a table is stored in (or written into) a physical memory of the microprocessor, then the index information may not have to be stored in (or written into) said dedicated memory. In this case, index information may be redundant information, because the labels which are used as index information, are usually specified in bit-fields of instruction formats and may be used to determine where the information associated with these labels is stored. E.g. if an entry of a table is specified as operand of an instruction, then the decoding of said instruction indicates to the microprocessor that it may find the information associated with (e.g. the value of ) said operand within said entry.

More generally, any information any data structure and any datum has an identifier (often called ‘tag’) which allows to distinguish said information, data structure and datum among other information, data structures and data. E.g. assume a region which contains 32 symbolic variables. One possible way to identify said symbolic variables is to label them upwards from 0 to 31. In this case, 5-bit labels are enough to uniquely identify (or encode) any variable out of the 32 variables.

The information (IF1) contained in the above mentioned tables and being part of one or more regions of structured symbolic machine code is now further described. It is important to see that the name and the number of tables given above is not relevant for the scope of the present invention. One could also store the information in one single table, where this table would then have to be organized such that one could make the same links between identifiers (table entries) and information associated with them than in the case of several tables. Any further details about the way in which said information is stored in said tables is not relevant for the scope of the present invention.

As mentioned before, it is important to see that the information (IF1) contained in the tables (Ta) to (Tf) is part of structured symbolic machine code and has to be considered in addition to the part of the machine code containing the proper instructions. Said information (IF1) usually does not contain instructions in the classical way. Formally, each of the tables contained in said information (IF1) could be defined as a complex instruction having possible a very large number of operands, e.g. the items stored in each data structure (e.g. a list or a table). E.g. a list containing one or more items may be encoded as follows:
(1) a bit-field (e.g. an identifier) uniquely identifying said list
(2) a bit-field specifying the total number of items contained in the list
(3) bit-fields specifying the data (e.g. any values) associated with each item

Said list could now be seen as an instruction where the concatenation of the bit-fields (1) and (2) specify the ‘opcode’ of the instruction and the bit-fields (3) specifying the instruction operands. E.g. if bit-field (1) is 00011010 and bit-field (2) is 10110, then the instruction opcode corresponding to this list would be the concatenation of 00011010+10110=0001101010110.

However, such an artificial definition of instructions is confusing and does not add anything to the scope of the present invention. Therefore, in order to ease the understanding, said information (IF1) is seen in the following as being a set of well defined block of data (e.g. data structures) which are part of structured symbolic machine code, but where said information (IF1) may have to be fetched by the microprocessor from some instruction memory or cache and may have to be decoded and stored into some dedicated memories before the part of the machine code containing the proper instructions can be fetched, scheduled and executed.

Since said information (IF1) contains several tables which are part of structured symbolic machine code, the index information used to index said tables may be part of the information associated with said tables. The information stored in each of the before mentioned tables, and being part of the symbolic machine code of said region (R1), are now further explained. A table, being part of the symbolic machine code of said region (R1), is said to be associated to that region, or more simply is said to be a table of that region.

A symbolic variable link table associated with said region (R1) is a table, e.g. a list, which is indexed (e.g. where the entries are specified) by the labels of symbolic variables of said region. In other words, each entry is specified by the label of a symbolic variable of said region and vice versa. E.g., if 5-bit labels are used to encode symbolic variables of a region, then the 5-bit label ‘00100’ specifies exactly one entry out of 2⁵=32 possible entries of said table and vice versa. Each entry (E1) of said table contains at least one or more of the following information:
the type of the symbolic variable specified by said entry (E1); e.g. the type may specify the number representation format of the value of said symbolic variable : e.g. in C++ either signed/unsigned byte, signed/unsigned integer, signed/unsigned long, float, double or long double etc . . .
the definition address of the symbolic variable specified by said entry (E1)
one or more labels (identifiers) specifying each a dependence group which the symbolic variable specified by said entry (E1) pertains to
the lexicographical order of the symbolic variable specified by said entry (E1)
the address variable associated with the symbolic variable specified by said entry (E1)
a flag which indicates whether the definition address of the symbolic variable specified by said entry (E1) is fixed (=does not change) during machine code execution or not
a flag which indicates whether the symbolic variable specified by said entry (E1) is data dependent or not
the WAR-lexicographical order of the symbolic variable specified by said entry (E1)
the RAW-lexicographical order of the symbolic variable specified by said entry (E1)
the WAW-lexicographical order of the symbolic variable specified by said entry (E1)

A constant link table associated with said region (R1) is a table (e.g. a list) which is indexed (e.g. where the entries are specified) by the labels of symbolic constants of said region and where each entry (E2) of said table contains one or more of the following information:
the type of a symbolic constant specified by said entry (E2); e.g. the type may specify the number representation format of the value of said symbolic constant: e.g. in C++ either signed/unsigned byte, signed/unsigned integer, signed/unsigned long, float, double or long double etc . . .
the value of the symbolic variable specified by said entry (E2)

If several symbolic constants with consecutive labels (entries) in this table are of the same type, only one of said entries has to contain the type of said symbolic constants. In this case however, the table must contain additional information that indicates that said entries contain constants of the same type.

A trace start address table associated with said region (R1) is a table (e.g. a list) which is indexed (e.g. where the entries are specified) by values obtained by concatenating the values and/or the labels of one or more predication variables stored in the BHT at some point in time during machine code execution, and where each entry of said table stores the address of an specific instruction pertaining to said region, usually the address of the first instruction to be fetched (=start address) from a specific trace of said region. A trace is a set of instructions pertaining to a branch path of said region. E.g. assume that, at some point in time during machine code execution, the BHT contains the 4-bit value 0010 which is obtained by concatenating the binary values of those 4 predication variables which determined the outcomes of the 4 most recently executed branches. Then said 4-bit value may be used to index the table, in other words to specify an entry out of 2⁴=16 possible entries of the trace start address table in order to get the desired instruction address. Another possibility consists in concatenating the values and the labels of the predication variables together in order to index the table. E.g. assume that the 4 before mentioned predication variables have the 3-bit labels 001, 010, 100 and 111 respectively. Then the concatenation of the values and the labels of said predication variables in some specific order is used for indexing (or in other words for specifying an entry of) the table. E.g. the concatenation of the values followed by the labels of the 4 mentioned predication variables would give a 16-bit indexing value: 0010+001+010+100+111=0010001010100111.

A pointer link table pertaining to said region (R1) is a table (or a list) which is indexed (e.g. where the entries are specified) by the labels of symbolic variables of said region, where said symbolic variables may refer to pointer variables declared in a source code program associated with said region and where each entry (E3) of said table contains the following information:
one or more labels (=identifiers) specifying each a dependence group which the symbolic variable specified by said entry (E3) pertains to

E.g., assume that said table and said region contain 32 entries and symbolic variables respectively and that they are both labeled from 0 to 31. In other words, to entry (with label) 0, 1, 2, . . . corresponds symbolic variable (with label) 0, 1, 2, . . . respectively. Then entry (with label) 7 could store the 4 labels 0, 3, 4, 5, where each of these labels specify a dependence group.

Region header Information associated with said region (R1) allows the microprocessor to:
1. identify said region (R1) among several other regions; e.g. this may be done by spending an unique identifier to each region being part of the whole machine code, the term ‘whole machine code’ meaning machine code containing the machine code of any considered region
2. determine the location of the before mentioned tables within the address space of the microprocessor; e.g. this can be done by spending branch addresses to the machine code where the information stored in said tables may be found
3. determine a program counter (PC) value which is associated with said region (R1); this PC value may be used as address offset to any address calculations of instructions or instances pertaining to said region
4. determine information which is stored both in a table associated to said region (R1) and in a table associated to a region other than region (R1); e.g. this is useful in order to determine the information shared between consecutively executed regions in order to minimize the size of the table information associated with each region; to this end one may spend a flag which indicates whether or not the information stored in the tables of two consecutively fetched or executed regions is identical

In order to support and optimize the execution of structured symbolic machine code on a microprocessor, it is advantageous to define new bit-fields in the instruction format of instructions specifying symbolic variables as operands and/or results. These kinds of bit-fields are not found in prior-art because they were not required due to the absence of symbolic variables.

In the following, it is assumed that each instruction of the instruction set of said microprocessor has an instruction format which may be different from the instruction format of another instruction of the instruction set. Furthermore, it is assumed in the following that said microprocessor has one or more register files and that any register file mentioned in the following refers to one of said microprocessor. Furthermore, it is assumed that a bit-field mentioned in the following is a bit-field within the instruction format of an instruction of said instruction set.

A first bit-field (B1) in this list of additional bit-fields is a bit-field which indicates:
whether the value of an instruction operand is stored in a register file or not
or whether the value of an instruction operand has to be written into a register file or not
or whether the value of an instruction result has to be written into a register file or not
   and where said instruction operand and said instruction result specify a symbolic variable. There may several bit-fields (B1) within the instruction format, e.g. one such bit-filed (B1) per instruction operand and per instruction result. It is explicitly mentioned that the expression ‘the value of an instruction operand is stored in a register file’ has the same meaning than the expression ‘the value of an instruction operand is found in a register file’. Furthermore, it is explicitly mentioned that when the value of an instruction operand or instruction result has not to be written into a register file, then said value has either to be written into the upper memory system (either into the L1- or L1 cache or main memory) or in any other memory. Therefore, bit-field (B1) as defined above may also indicate whether the value of an instruction operand or of an instruction result has to be written into the upper memory system or not.

A first simple example shall clarify the meaning of bit-field (B1). Assume that a considered instruction has just one instruction result. If the value specified by the bit-field (B1) corresponding to the instruction result is logical ‘1’, then this may mean that instruction result has to be written into the register file, otherwise if the value specified by bit-field (B1) is logical ‘0’, then this may mean that the instruction result has not to be written into the register file.

The meaning of bit-field (B1) is independent of the pipeline stage the corresponding instruction is in, e.g. independent of whether the corresponding instruction is being fetched, decoded, dispatched or executed. Furthermore, one should note that writing the value of an operand into a register file is not a contradiction because an operand, after having been loaded into some memory (usually the register file), may well have to be stored in some other memory afterwards. Bit-field (B1) has a different meaning from prior-art cache specifiers because cache specifiers only indicate whether the loading/storing of a value should be done from or to a specific cache or memory, but not from or to a register file. This is because cache specifiers do not consider symbolic variables. By definition, symbolic variables can be stored to or loaded from anywhere in the memory hierarchy, also to or from a register file.

Bit-field (B1) may have a different meaning in combination with other bit-fields (Bx) specified in the instruction format of any instruction. E.g. consider two instructions (Is) and (It) being part of a machine code and assume that the bit-fields (B1) and (Bx) are part of the instruction format of each instruction. In this case, the values specified by the bit-fields (Bx) within the instruction format of instruction (It) may well determine the meaning of the bit-field (B1) within the instruction format of instruction (Is).

In particular, the meaning of bit-field (B1) may depend on the values stored in one or more predication registers or predication variables. As before, these predication registers or predication variables may be specified in bit-fields within the instruction format of any instruction. E.g. bit-field (B1) may indicate whether the value of a result of an instruction (I1) has to be written into a register file or not, and this depending on the value stored in a predication register specified in a corresponding bit-field within the instruction format either of instruction (I1) or of another instruction. Furthermore, said predication registers and predication variables may also refer to those stored in a branch history table. One should note that the values of said predication variables and the values stored in said predication registers may be predicted values and may not yet be confirmed to be correct at the point in time when said operand shall be loaded from the register file.

Another more elaborate example shall show another possibility on how the meaning of bit-field (B1) may depend on value of predication registers and predication variables. Consider an instruction (I1) having an instruction format which contains a bit-field (Ba) of 4 bits specifying one out of 16 possible predication variables of a hyper-block which said instruction (I1) pertains to. Assume that the instruction format of instruction (I1) further contains a bit-field (Bb) of 1 bit specifying whether the value of an operand of instruction (I1) is stored in a register file or not. If the value of a predication variable (Pa) which is dependent the predication variable specified by bit-field (Ba) is logical ‘1’ and if the value specified by (Bb) is logical ‘0’ then the value of said operand is found in a register file and may have to be loaded from that register file. However, if the value stored in the predication variable (Pa) is logical ‘0’, then the value specified by bit-field (Bb) is not relevant. In this particular case, it may be interesting to spend two bit-fields (Bb) which specify for each of the two possible values of predication variable (Pa) whether an operand is found in a register file or not.

A second bit-field (B2) in this list of additional bit-fields indicates whether a symbolic variable is specified either for the first time or for the last time by an operand and/or result of an instruction within a region or not. Formally, bit-field (B2) is defined to be a bit-field which indicates whether a symbolic variable specified by an operand and/or result of an instruction (I2) is specified by an operand and/or result of another instruction (I3) or not, and where instruction (I3) may enter or may have to enter a certain pipeline stage either before or after instruction (I2) enters or is allowed to enter a certain pipeline stage. E.g. bit-field (B2) may indicate whether a symbolic variable specified by an operand of instruction (I2) is specified by an operand of another instruction (I4) or not, and where instruction (I4) will be fetched after instruction (I2) is fetched.

In the same way as for bit-field (B1), bit-field (B2) may have a different meaning in combination with other bit-fields of the instruction format. As for bit-field (B1), there maybe one such bit-field (B2) per instruction operand and per instruction result.

A third bit-field (B3) in this list of additional bit-fields indicates whether a symbolic variable specified by an instruction operand or by an instruction result is data dependent or not. It is recalled that a symbolic variable is data dependent if it pertains to a non-empty dependence group. As for first bit-field (B1), bit-field (B3) may have a different meaning in combination with other bit-fields of the instruction format. As for bit-field (B1), there maybe one such bit-field (B3) per instruction operand and per instruction result.

A fourth bit-field (B4) in this list of additional bit-fields is a bit-field which specifies an instruction. More precisely, if bit-field (B4) pertains to the instruction format of an instruction (IQ), then bit-field (B4) specifies an instruction (IP), and where instruction (IP) may have to enter a certain pipeline stage either before or after instruction (IQ) enters or is allowed to enter a certain pipeline stage. Instruction (IQ) is said to be dependent on instruction (IP). E.g. this could mean that instruction (IP) must have to be executed before instruction (IQ) is allowed to execute.

Instruction (IP) may be specified in several ways. One possible way consists of dynamically assigning labels to instructions in increasing order according to their fetching order and to specify instruction (IP) by the arithmetic difference between the labels assigned to instruction (IQ) and to instruction (IP). E.g. assume that instruction (IQ) gets assigned label 13 when being fetched and that bit-field (B4) within the instruction format of that instruction indicates ‘4’ as the arithmetic difference between the labels assigned to instructions (IP) and (IQ). This means then that instruction (IP) is the instruction that gets assigned label 17=13+4 when being fetched. As for bit-field (B1), bit-field (B4) may have a different meaning in combination with other bit-fields of the instruction format.

Bit-field (B4) has several purposes:
to indicate a data dependence (RAW, WAW or WAR dependence) between instructions
or to impose a specific scheduling order between instructions

Since structured symbolic machine code is particularly interesting in combination with autonomous load/store, it is useful to define an instruction (IR) which, when it enters a certain pipeline stage, indicates that certain symbolic variables (SV) are no longer used and their values, which are stored maybe in some registers, may be overwritten. Said symbolic variables (SV) may be specified in corresponding bit-fields of instruction (IR) and they may be seen as the operands of instruction (IR). Instruction (IR) has the purpose of allowing the compiler to insert explicit garbage collection information into the machine code. Instruction (IR) has the effect that the registers, which hold the values of said symbolic variables (SV), are released (or freed up) such that they are available for storing the values of other symbolic variables.

A fifth bit-field (B5) in this list of additional bit-fields is a bit-field which specifies whether or not a symbolic variable specified as instruction result may be allocated to the same register as the one to which one of the instruction operands is allocated. It is recalled that if a symbolic variable is allocated to some register, then this means that the value of said symbolic variable may be stored or written in said register. The allocation may be static or dynamic. If the allocation is static, the allocation of symbolic variables to registers does not change during runtime. If the allocation is dynamic, then the allocation may change during runtime. E.g. assume an instruction which specifies a symbolic variable (SV1) as instruction operand and a symbolic variable (SV2) as instruction result and assume that symbolic variable SV1 is allocated to some register (rf). Then if said bit-field (BF5) is set, this means that the value of symbolic variable (SV2) may be stored in said register (rf), thus overwriting the value of symbolic variable (SV2). There may be one such bit-field (B5) per instruction operand. In other words, if a bit-field (B5) is associated to some instruction operand (opd1), then said bit-field indicates whether or not a symbolic variable specified as instruction result may be allocated to the same register as the one to which instruction operand (opd1) is allocated.

A sixth bit-field (B6) in this list of additional bit-fields is a bit-field which specifies whether or not the value of a symbolic variable (sv4) specified as instruction result is the value of the definition address of said symbolic variable (sv4).

A seventh bit-field (B7) in this list of additional bit-fields is a bit-field which specifies whether or not the value of a symbolic variable specified as instruction result is the value of a predication variable.

A eighth bit-field (B8) in this list of additional bit-fields is a bit-field which specifies whether or not the value of a symbolic variable (sx) specified as instruction result corresponds to a branch address. E.g. if the value of symbolic variable (sx) is the decimal value 345, then said bit-field (B8) indicates whether or not this value corresponds to a branch address having the same value. Said branch address may also be obtained by adding said value 345 to some program counter or offset.

Before closing this section, the advantages of structured symbolic machine code over conventional machine code may be summarized as follows:
1. due to the fact that the information stored in the tables (Ta) to (Tb) is highly compressed and due to the fact that symbolic machine code makes the use of explicit load/store instructions obsolete, the code size of structured symbolic machine code is substantially smaller than for conventional machine code
2. linear storing of the listing information stored in the before mentioned tables allows the microprocessor to access this information in parallel and to achieve a very high fetch bandwidth limited only be the fetch bandwidth of the instruction cache; therefore, although the information stored in the before mentioned tables has to be fetched, decoded and stored into one or more dedicated caches within the microprocessor before the fetching and executing of the proper instructions of a region can start, the time overhead for doing so is small

### 5. SUMMARY OF THE INVENTION

The present invention concerns a method for executing structured symbolic machine code on a microprocessor.

What is claimed is:

1. a method for executing structured symbolic machine code on a microprocessor,
where said microprocessor is part of a data processing system containing a memory system,
where said memory system is defined to have a memory hierarchy containing:
one or more register files of said microprocessor
one or more data caches at different memory hierarchy levels
a main memory
where said microprocessor is able to perform speculative branch prediction,
where said speculative branch prediction is based on a branch history which may store outcomes of branches which are not yet resolved at the point in time when a branch prediction is being made,
where unresolved branch outcomes may update counter states within the branch history,
where said counter states may concern counter states stored in a pattern history table,
where said microprocessor has an instruction set containing one or more instructions of which one or more operands and/or results may specify one or more symbolic variables,
where said structured symbolic machine code contains one or more regions, where at least one (R1) of said regions contains symbolic machine code containing one of or both of the following information:
information (IF1)
information (IF2)
where said region (R1) may further contain one or more of the following information:
information (IF3)
information (IF4)
information (IF5)
information (IF6)
where said information (IF1) to (IF6) may be stored into one or more dedicated memories within the microprocessor during the execution of said structured symbolic machine code,
where the symbolic machine contained in each of said regions contains one or more instructions of which one or more operands and/or results specify one or more symbolic variables,
where each of said symbolic variables specifies one or more entries (Es) of a memory other than a register file of said microprocessor,
where said entries (Es) are used by the microprocessor in order to determine the addresses within the memory hierarchy where the values of said symbolic variables may or may have to be stored to and/or loaded from during execution of said structured symbolic machine code,
where said information (IF1) contains:
a symbolic variable (S1) of said region (R1)
a definition address of said symbolic variable (S1)
where said information (IF1) may further contain one or more of the following information
the type of said symbolic variable (S1)
one or more labels specifying each a dependence group which said symbolic variable (S1) pertains to
the lexicographical order of said symbolic variable (S1)
an address variable associated with said symbolic variable (S1)
a flag which indicates whether said definition address is fixed during machine code execution or not
the WAR-lexicographical order of said symbolic variable (S1)
the RAW-lexicographical order of said symbolic variable (S1)
the WAW-lexicographical order of said symbolic variable (S1)
where said information (IF2) contains a symbolic constant (C1) of said region (R1) and one or both of the following information:
the type of said symbolic constant (C1)
the value of said symbolic constant (C1)
where said information (IF3) contains:
a node (N1) of a branch tree associated with said region (R1)
one or more successor nodes of said node (N1)
where said information (IF3) may further contain one or more of the following information:
a symbolic variable associated with node (N1) and which is used as a predication variable of a predicated instruction of said region (R1)
a branch address associated with said node (N1)
a branch address associated with a successor node of said node (N1)
the number of instructions associated with said node (N1)
none, one or more branch counts associated with said node (N1), where said branch counts may be used to do a correct updating of counter states of said pattern history table after branch miss-predictions have occurred, and where each of said branch counts may correspond to the counter state of a counter within the pattern history table at the point in time when or before the prediction of the value (V1) of a predication variable associated with said node (N1) shall start or shall be done and where said counter state may be used in the prediction of said value (V1)
a branch flag associated with said node (N1), where said branch flag indicates whether there is just one successor node of said node (N1) or not
a branch-back-flag associated to a successor node of said node (N1), where said branch-back-flag indicates whether the following two conditions are satisfied or not:
1. said successor node belongs to the same region as said node (N1)
2. there exists a branch path through the region from said successor node to said node (N1)
a region-flag associated to a successor node of said node (N1), where said region-flag indicates whether said successor node belongs to the same region than said node (N1) or not
a function-flag associated to a successor node of said node (N1), where said function-flag indicates whether the following two conditions are satisfied or not:
1. said successor node belongs to another region (rx) than said node (N1)
2. said region (rx) contains machine code which is associated to the source code of a function declaration or definition
an exit-flag associated to a successor node of said node (N1), where said exit-flag indicates whether the following two conditions are satisfied or not:
1. said successor node belongs to another region than said node (N1)
2. the branch address associated to said successor node is not known statically before runtime and may be determined dynamically by the microprocessor during machine code execution
where said microprocessor may dynamically generate, during machine code execution, one or more branch counts associated with said node (N1), by setting each of said branch counts equal to the counter state of a counter within the pattern history table at the point in time when or before the prediction of the value (V3) of a predication variable associated with said node (N1) shall start or shall be done, where said branch counts may be used to do a correct updating of counter states of said pattern history table after branch miss-predictions have occurred, and where said counter states may be used in the prediction of said value (V3),
where said information (IF4) contains:
a value (V2) obtained by concatenating the values and/or the labels of one or more predication variables stored in said branch history table at some point in time during machine code execution
an address (A1) associated with said value (V2), where said address (A1) is the address of a specific instruction pertaining to said region (R1) and where said address (A1) may correspond to the start address of a trace within said region (R1)
where said information (IF5) contains:
a symbolic variable (S2) of said region (R1)
one or more labels specifying each a dependence group which the symbolic variable (S2) pertains to
where said information (IF6) is associated with said region (R1) and allows the microprocessor to:
identify said region (R1) among several other regions
determine the location of the before mentioned information (IF1) to (IF5) within the address space of the microprocessor
determine a program counter value which is associated with said region (R1)
determine which part of the information (IF1) to (IF5) is common both to said region (R1) and to a region other than region (R1)

2. a microprocessor for executing structured symbolic machine code,
where said microprocessor is part of a data processing system containing a memory system,
where said memory system is defined to have a memory hierarchy containing:
one or more register files of said microprocessor
one or more data caches at different memory hierarchy levels
a main memory
where said microprocessor is able to perform speculative branch prediction,
where said speculative branch prediction is based on a branch history which may store outcomes of branches which are not yet resolved at the point in time when a branch prediction is being made,
where unresolved branch outcomes may update counter states within the branch history,
where said counter states may concern counter states stored in a pattern history table,
where said microprocessor has an instruction set containing one or more instructions of which one or more operands and/or results may specify one or more symbolic variables,
where said structured symbolic machine code contains one or more regions, where at least one (R2) of said regions contains symbolic machine code containing one or both of the following information:
information (IF7)
information (IF8)
where said region (R2) may further contain one or more of the following information:
information (IF9)
information (IF10)
information (IF11)
information (IF12)
where said information (IF7) to (IF12) may be stored into one or more dedicated memories within the microprocessor during the execution of said structured symbolic machine code,
where the symbolic machine contained in each of said regions contains one or more instructions of which one or more operands and/or results specify one or more symbolic variables,
where each of said symbolic variables specifies one or more entries (Et) of a memory other than a register file of said microprocessor,
where said entries (Et) are used by the microprocessor in order to determine the addresses within the memory hierarchy where the values of said symbolic variables may or may have to be stored to and/or loaded from during execution of said structured symbolic machine code,
where said information (IF7) contains a symbolic variable (S5) of said region (R2), said information (IF7) being used by said microprocessor to determine a definition address of said symbolic variable (S5), where said information (IF7) may further be used by said microprocessor to determine one or more of the following:
the type of said symbolic variable (S5)
one or more labels specifying each a dependence group which said symbolic variable (S5) pertains to
the lexicographical order of said symbolic variable (S5)
an address variable associated with said symbolic variable (S5)
a flag which indicates whether said definition address is fixed during machine code execution or not
the WAR-lexicographical order of said symbolic variable (S5)
the RAW-lexicographical order of said symbolic variable (S5)
the WAW-lexicographical order of said symbolic variable (S5)
where said information (IF8) contains a symbolic constant (C2) of said region (R2), said information (IF8) being used by said microprocessor to determine the type and/or the value of said symbolic constant (C2),
where information (IF9) contains:
a node (N2) of a branch tree associated with said region (R2)
one or more successor nodes of said node (N2)
where said information (IF9) may further be used by said microprocessor to determine one or more of the following:
a symbolic variable associated with said node (N2) and which is used as a predication variable of a predicated instruction of said region (R2)
a branch address associated with said node (N2)
a branch address associated with a successor node of said node (N2)
the number of instructions associated with said node (N2)
one or more branch counts associated with said node (N2), where said branch counts may be used to do a correct updating of counter states of said pattern history table after branch miss-predictions have occurred, and where each of said branch counts may correspond to the counter state of a counter within the pattern history table at the point in time when or before the prediction of the value (V4) of a predication variable associated with said node (N2) shall start or shall be done and where said counter state may be used in the prediction of said value (V4)
a branch flag associated with said node (N2), where said branch flag indicates whether there is just one successor node of said node (N2) or not
a branch-back-flag associated to a successor node of said node (N2), where said branch-back-flag indicates whether the following two conditions are satisfied or not:
1. said successor node belongs to the same region as said node (N2)
2. there exists a branch path through the region from said successor node to said node (N2)
a region-flag associated to a successor node of said node (N2), where said region-flag indicates whether said successor node belongs to the same region than said node (N2) or not
a function-flag associated to a successor node of said node (N2), where said function-flag indicates whether the following two conditions are satisfied or not:
1. said successor node belongs to another region (rx) than said node (N2)
2. said region (rx) contains machine code which is associated to the source code of a function declaration or definition
an exit-flag associated to a successor node of said node (N2), where said exit-flag indicates whether the following two conditions are satisfied or not:
1. said successor node belongs to another region than said node (N2)
2. the branch address associated to said successor node is not known statically before runtime and may be determined dynamically by the microprocessor during machine code execution
where said microprocessor may dynamically generate, during machine code execution, one or more branch counts associated with said node (N2) by setting each of said branch counts equal to the counter state of a counter within the pattern history table at the point in time when or before the prediction of the value (V6) of a predication variable associated with said node (N2) shall start or shall be done and by storing said branch counts in some dedicated memory, where said branch counts may be used to do a correct updating of counter states of said pattern history table after branch miss-predictions have occurred, and where said counter states may be used in the prediction of said value (V6),
where said information (IF10) contains a value (V5) obtained by concatenating the values and/or the labels of one or more predication variables stored in said branch history table at some point in time during machine code execution, said information (IF10) being used by said microprocessor to determine an address (A2) associated with said value (V5), where said address (A2) is the address of a specific instruction pertaining to said region (R2) and where said address (A2) may correspond to the start address of a trace within said region (R2),
where said information (IF11) contains a symbolic variable (S6) of said region (R2) and where said symbolic variable (S6) may correspond to a pointer variable declared in a source code program associated with said region (R2), said information (IF11) being used by said microprocessor to determine one or more labels specifying each a dependence group which the symbolic variable (S6) pertains to
where said information (IF12) is associated with said region (R2) and allows the microprocessor to:
identify said region (R2) among several other regions
determine the location of the before mentioned information (IF7) to (IF11) within the address space of the microprocessor
determine a program counter value which is associated with said region (R2)
determine which part of the information (IF7) to (IF11) is common both to said region (R2) and to a region other than region (R2)

3. A method as claimed in claim 1,
where said region (R1) contains symbolic machine code containing one of or both of the following information:
information (IF1)
information (IF2)
where said region (R1) further contains one or more of the following information:
information (IF3)
information (IF4)
information (IF5)
information (IF6)

4. A microprocessor as claimed in claim 2.,
where said region (R2) contains symbolic machine code containing one of or both of the following information:
information (IF7)
information (IF8)
where said region (R1) further contains one or more of the following information:
information (IF9)
information (IF10)
information (IF11)
information (IF12)

5. A method as claimed in claim 3.,
where said region (R1) contains symbolic machine code containing said information (IF1), (IF2), (IF3), (IF4), (IF5) and (IF6),
where information (IF1) is a table (T1) which is indexed by the labels of one or more symbolic variables of said region (R1), and where each entry (E1) of said table (T1) contains the following information:
the type of the symbolic variable specified by said entry (E1)
a definition address of the symbolic variable specified by said entry (E1)
one or more labels specifying each a dependence group which the symbolic variable specified by said entry (E1) pertains to
an address variable associated with the symbolic variable specified by said entry (E1)
a flag which indicates whether said definition address of the symbolic variable specified by said entry (E1) is fixed during machine code execution or not
where information (IF2) is a table (T2) indexed by the labels of one or more symbolic constants of said region (R1) and where each entry (E2) of said table (T2) contains the type and/or the value of a symbolic constant specified by said entry (E2),
where information (IF3) is a table (T3) indexed by labels of one or more nodes of a branch tree associated with said region (R1) and where each entry (E3) of table (T3) contains the following information:
one or more successor nodes of the node specified by said entry (E3)
a symbolic variable (S9) associated with the node specified by said entry (E3), where said symbolic variable (S9) is a predication variable of a predicated instruction of said region (R1)
a branch address associated with the node specified by said entry (E3)
a branch address associated with a successor node of the node specified by said entry (E3)
the number of instructions associated with the node specified by said entry (E3)
none, one or more branch counts associated with the node specified by said entry (E3), where said branch counts may be used to do a correct updating of counter states of said pattern history table after branch miss-predictions have occurred, and where each of said branch counts may correspond to the counter state of a counter within the pattern history table at the point in time when or before the prediction of the value (V9) of said predication variable (S9) shall start or shall be done and where said counter state may be used in the prediction of said value (V9)
a branch flag associated with said entry (E3), where said branch flag indicates whether there is just one successor node of the node specified by said entry (E3) or not
a branch-back-flag associated to a successor node of the node specified by said entry (E3), where said branch-back-flag indicates whether the following two conditions are satisfied or not:
1. said successor node belongs to the same region as the node specified by said entry (E3)
2. there exists a branch path through the region from said successor node to the node specified by said entry (E3)
a region-flag associated to a successor node of the node specified by said entry (E3), where said region-flag indicates whether said successor node belongs to the same region than the node specified by said entry (E3) or not
a function-flag associated to a successor node of the node specified by said entry (E3), where said function-flag indicates whether the following two conditions are satisfied or not:
1. said successor node belongs to another region (rx) than the node specified by said entry (E3)
2. said region (rx) contains machine code which is associated to the source code of a function declaration or definition
an exit-flag associated to a successor node of the node specified by said entry (E3), where said exit-flag indicates whether the following two conditions are satisfied or not:
1. said successor node belongs to another region than the node specified by said entry (E3)
2. the branch address associated to said successor node is not known statically before runtime and may be determined dynamically by the microprocessor during machine code execution
where said microprocessor may dynamically generate, during machine code execution, one or more branch counts associated with said node specified by said entry (E3) by setting each of said branch counts equal to the counter state of a counter within the pattern history table at the point in time when or before the prediction of the value (Vp) of a predication variable associated with said entry (E3) shall start or shall be done and by storing said branch counts in some dedicated memory, where said branch counts may be used to do a correct updating of counter states of said pattern history table after branch miss-predictions have occurred, and where said counter states may be used in the prediction of said value (Vp),
where information (IF4) is a table (T4) indexed by a value (V10) obtained by concatenating the values and/or the labels of one or more predication variables stored in said branch history table at some point in time during machine code execution, and where each entry of said table (T4) stores an address (A3) associated with said value (V10), where said address (A3) is the address of a specific instruction pertaining to said region (R1) and where said address (A3) may correspond to the start address of a trace within said region (R1),
where information (IF5) is a table (T5) indexed by the labels of one or more symbolic variables of said region (R1), where said symbolic variables may refer to pointer variables declared in a source code program associated with said region (R1) and where each entry (E4) of said table (T5) contains one or more labels specifying each a dependence group which the symbolic variable specified by said entry (E4) pertains to

6. A microprocessor as claimed in claim 4.,
where said region (R2) contains symbolic machine code containing said information (IF7), (IF8), (IF9), (IF10), (IF12) and (IF12),
where information (IF7) is a table (T7) which is indexed by the labels of one or more symbolic variables of said region (R2), and where each entry (E5) of said table (T7) contains the following information:
the type of the symbolic variable specified by said entry (E5)
a definition address of the symbolic variable specified by said entry (E1)
one or more labels specifying each a dependence group which the symbolic variable specified by said entry (E5) pertains to
an address variable associated with the symbolic variable specified by said entry (E5)
a flag which indicates whether said definition address of the symbolic variable specified by said entry (E5) is fixed during machine code execution or not
where information (IF8) is a table (T8) indexed by the labels of one or more symbolic constants of said region (R2) and where each entry (E6) of said table (T8) contains the type and/or the value of a symbolic constant specified by said entry (E6),
where information (IF9) is a table (T9) indexed by labels of one or more nodes of a branch tree associated with said region (R2) and where each entry (E7) of table (T9) contains the following information:
one or more successor nodes of the node specified by said entry (E7)
a symbolic variable (S10) associated with the node specified by said entry (E7), where said symbolic variable (S10) is a predication variable of a predicated instruction of said region (R2)
a branch address associated with the node specified by said entry (E7)
a branch address associated with a successor node of the node specified by said entry (E7)
the number of instructions associated to the node specified by said entry (E7)
none, one or more branch counts associated with the node specified by said entry (E7), where said branch counts may be used to do a correct updating of counter states of said pattern history table after branch miss-predictions have occurred, and where each of said branch counts may correspond to the counter state of a counter within the pattern history table at the point in time when or before the prediction of the value (V11) of said predication variable (S10) shall start or shall be done and where said counter state may be used in the prediction of said value (V11)
a branch flag associated with said entry (E7), where said branch flag indicates whether there is just one successor node of the node specified by said entry (E7) or not
a branch-back-flag associated to a successor node of the node specified by said entry (E7), where said branch-back-flag indicates whether the following two conditions are satisfied or not:
1. said successor node belongs to the same region as the node specified by said entry (E7)
2. there exists a branch path through the region from said successor node to the node specified by said entry (E7)
a region-flag associated to a successor node of the node specified by said entry (E7), where said region-flag indicates whether said successor node belongs to the same region than the node specified by said entry (E7) or not
a function-flag associated to a successor node of the node specified by said entry (E7), where said function-flag indicates whether the following two conditions are satisfied or not:
1. said successor node belongs to another region (rx) than the node specified by said entry (E7)
2. said region (rx) contains machine code which is associated to the source code of a function declaration or definition
an exit-flag associated to a successor node of the node specified by said entry (E7), where said exit-flag indicates whether the following two conditions are satisfied or not:
1. said successor node belongs to another region than the node specified by said entry (E7)
2. the branch address associated to said successor node is not known statically before runtime and may be determined dynamically by the microprocessor during machine code execution
where said microprocessor may dynamically generate, during machine code execution, one or more branch counts associated with said node specified by said entry (E7) by setting each of said branch counts equal to the counter state of a counter within the pattern history table at the point in time when or before the prediction of the value (Vq) of a predication variable associated with said entry (E7) shall start or shall be done and by storing said branch counts in some dedicated memory, where said branch counts may be used to do a correct updating of counter states of said pattern history table after branch miss-predictions have occurred, and where said counter states may be used in the prediction of said value (Vq),
where information (IF10) is a table (T10) indexed by a value (V12) obtained by concatenating the values and/or the labels of one or more predication variables stored in said branch history table at some point in time during machine code execution, and where each entry of said table (T10) stores an address (A4) associated with said value (V12), where said address (A4) is the address of a specific instruction pertaining to said region (R2) and where said address (A4) may correspond to the start address of a trace within said region (R2),
where information (IF11) is a table (T11) indexed by the labels of one or more symbolic variables of said region (R2), where said symbolic variables may refer to pointer variables declared in a source code program associated with said region (R2) and where each entry (E8) of said table (T11) contains one or more labels specifying each a dependence group which the symbolic variable specified by said entry (E8) pertains to

7. A method as claimed in claim 1.,
where one or more instructions of the instruction set of said microprocessor may have an instruction format containing a bit-field (B10) which indicates:
whether the value of an instruction operand is stored in a register file or not
or whether the value of an instruction operand has to be written into a register file or not
or whether the value of an instruction result has to be written into a register file or not
and where said instruction operand and said instruction result specify a symbolic variable, and where the meaning of the bit-field (B10) may depend on the meaning of other bit-fields of the instruction format of any instruction of said instruction set,
where one or more instructions of the instruction set of said microprocessor may have an instruction format containing a bit-field (B11) which indicates whether a symbolic variable specified by an operand and/or result of an instruction (I7) is specified by an operand and/or result of another instruction (I8) or not, and where instruction (I8) may enter or may have to enter a certain pipeline stage either before or after instruction (I7) enters or is allowed to enter a certain pipeline stage, where the meaning of the bit-field (B11) may depend on the meaning of other bit-fields of the instruction format of any instruction of said instruction set,
where one or more instructions of the instruction set of said microprocessor may have an instruction format containing a bit-field (B13) which indicates whether a symbolic variable specified by an instruction operand and/or an instruction result is data dependent or not,
where the meaning of the bit-field (B13) may depend on the meaning of other bit-fields of the instruction format of any instruction of said instruction set,
where at least one instruction (I9) of the instruction set of said microprocessor may have an instruction format containing a bit-field (B12) which specifies an instruction (I10), and where instruction (I10) may have to enter a certain pipeline stage either before or after instruction (I9) enters or is allowed to enter a certain pipeline stage,
where the meaning of the bit-field (B12) may depend on the meaning of other bit-fields of the instruction format of any instruction of said instruction set,
where said microprocessor may have an instruction which, when it enters a certain pipeline stage, indicates that certain symbolic variables (Sk) are no longer used and that the values of symbolic variables (Sk) may be overwritten
where one or more instructions of the instruction set of said microprocessor may have an instruction format containing a bit-field (B14) which specifies whether or not a symbolic variable specified as instruction result may be allocated to the same register as the one to which one of the instruction operands is allocated
where one or more instructions of the instruction set of said microprocessor may have an instruction format containing a bit-field (B15) which specifies whether or not the value of a symbolic variable (sv4) specified as instruction result is the value of the definition address of said symbolic variable (sv4)
where one or more instructions of the instruction set of said microprocessor may have an instruction format containing a bit-field (B16) which specifies whether or not the value of a symbolic variable specified as instruction result is the value of a predication variable
where one or more instructions of the instruction set of said microprocessor may have an instruction format containing a bit-field (B17) which specifies whether or not the value of a symbolic variable specified as instruction result corresponds to a branch address

8. A microprocessor as claimed in claim 2.,
where one or more instructions of the instruction set of said microprocessor may have an instruction format containing a bit-field (B10) which indicates:
whether the value of an instruction operand is stored in a register file or not
or whether the value of an instruction operand has to be written into a register file or not
or whether the value of an instruction result has to be written into a register file or not
and where said instruction operand and said instruction result specify a symbolic variable,
where the meaning of the bit-field (B10) may depend on the meaning of other bit-fields of the instruction format of any instruction of said instruction set,
where one or more instructions of the instruction set of said microprocessor may have an instruction format containing a bit-field (B11) which indicates whether a symbolic variable specified by an operand and/or result of an instruction (I7) is specified by an operand and/or result of another instruction (I8) or not, and where instruction (I8) may enter or may have to enter a certain pipeline stage either before or after instruction (I7) enters or is allowed to enter a certain pipeline stage, where the meaning of the bit-field (B11) may depend on the meaning of other bit-fields of the instruction format of any instruction of said instruction set,
where one or more instructions of the instruction set of said microprocessor may have an instruction format containing a bit-field (B13) which indicates whether a symbolic variable specified by an instruction operand and/or an instruction result is data dependent or not,
where the meaning of the bit-field (B13) may depend on the meaning of other bit-fields of the instruction format of any instruction of said instruction set,
where at least one instruction (I9) of the instruction set of said microprocessor may have an instruction format containing a bit-field (B12) which specifies an instruction (I10), and where instruction (I10) may have to enter a certain pipeline stage either before or after instruction (I9) enters or is allowed to enter a certain pipeline stage,
where the meaning of the bit-field (B12) may depend on the meaning of other bit-fields of the instruction format of any instruction of said instruction set,
where said microprocessor may have an instruction which, when it enters a certain pipeline stage, indicates that certain symbolic variables (Sk) are no longer used and that the values of symbolic variables (Sk) may be overwritten
where one or more instructions of the instruction set of said microprocessor may have an instruction format containing a bit-field (B14) which specifies whether or not a symbolic variable specified as instruction result may be allocated to the same register as the one to which one of the instruction operands is allocated
where one or more instructions of the instruction set of said microprocessor may have an instruction format containing a bit-field (B15) which specifies whether or not the value of a symbolic variable (sv4) specified as instruction result is the value of the definition address of said symbolic variable (sv4)
where one or more instructions of the instruction set of said microprocessor may have an instruction format containing a bit-field (B16) which specifies whether or not the value of a symbolic variable specified as instruction result is the value of a predication variable
where one or more instructions of the instruction set of said microprocessor may have an instruction format containing a bit-field (B17) which specifies whether or not the value of a symbolic variable specified as instruction result corresponds to a branch address

9. A method as claimed in claim 3.,
where one or more instructions of the instruction set of said microprocessor may have an instruction format containing a bit-field (B10) which indicates:
whether the value of an instruction operand is stored in a register file or not
or whether the value of an instruction operand has to be written into a register file or not
or whether the value of an instruction result has to be written into a register file or not
and where said instruction operand and said instruction result specify a symbolic variable, where the meaning of the bit-field (B10) may depend on the meaning of other bit-fields of the instruction format of any instruction of said instruction set,
where one or more instructions of the instruction set of said microprocessor may have an instruction format containing a bit-field (B11) which indicates whether a symbolic variable specified by an operand and/or result of an instruction (I7) is specified by an operand and/or result of another instruction (I8) or not, and where instruction (I8) may enter or may have to enter a certain pipeline stage either before or after instruction (I7) enters or is allowed to enter a certain pipeline stage,
where the meaning of the bit-field (B11) may depend on the meaning of other bit-fields of the instruction format of any instruction of said instruction set,
where one or more instructions of the instruction set of said microprocessor may have an instruction format containing a bit-field (B13) which indicates whether a symbolic variable specified by an instruction operand and/or an instruction result is data dependent or not,
where the meaning of the bit-field (B13) may depend on the meaning of other bit-fields of the instruction format of any instruction of said instruction set,
where at least one instruction (I9) of the instruction set of said microprocessor may have an instruction format containing a bit-field (B12) which specifies an instruction (I10), and where instruction (I10) may have to enter a certain pipeline stage either before or after instruction (I9) enters or is allowed to enter a certain pipeline stage,
where the meaning of the bit-field (B12) may depend on the meaning of other bit-fields of the instruction format of any instruction of said instruction set,
where said microprocessor may have an instruction which, when it enters a certain pipeline stage, indicates that certain symbolic variables (Sk) are no longer used and that the values of symbolic variables (Sk) may be overwritten
where one or more instructions of the instruction set of said microprocessor may have an instruction format containing a bit-field (B14) which specifies whether or not a symbolic variable specified as instruction result may be allocated to the same register as the one to which one of the instruction operands is allocated
where one or more instructions of the instruction set of said microprocessor may have an instruction format containing a bit-field (B15) which specifies whether or not the value of a symbolic variable (sv4) specified as instruction result is the value of the definition address of said symbolic variable (sv4)
where one or more instructions of the instruction set of said microprocessor may have an instruction format containing a bit-field (B16) which specifies whether or not the value of a symbolic variable specified as instruction result is the value of a predication variable
where one or more instructions of the instruction set of said microprocessor may have an instruction format containing a bit-field (B17) which specifies whether or not the value of a symbolic variable specified as instruction result corresponds to a branch address

10. A microprocessor as claimed in claim 4.,
where one or more instructions of the instruction set of said microprocessor may have an instruction format containing a bit-field (B10) which indicates:
whether the value of an instruction operand is stored in a register file or not
or whether the value of an instruction operand has to be written into a register file or not
or whether the value of an instruction result has to be written into a register file or not
and where said instruction operand and said instruction result specify a symbolic variable, where the meaning of the bit-field (B10) may depend on the meaning of other bit-fields of the instruction format of any instruction of said instruction set,
where one or more instructions of the instruction set of said microprocessor may have an instruction format containing a bit-field (B11) which indicates whether a symbolic variable specified by an operand and/or result of an instruction (I7) is specified by an operand and/or result of another instruction (I8) or not, and where instruction (I8) may enter or may have to enter a certain pipeline stage either before or after instruction (I7) enters or is allowed to enter a certain pipeline stage, where the meaning of the bit-field (B11) may depend on the meaning of other bit-fields of the instruction format of any instruction of said instruction set,
where one or more instructions of the instruction set of said microprocessor may have an instruction format containing a bit-field (B13) which indicates whether a symbolic variable specified by an instruction operand and/or an instruction result is data dependent or not,
where the meaning of the bit-field (B13) may depend on the meaning of other bit-fields of the instruction format of any instruction of said instruction set,
where at least one instruction (I9) of the instruction set of said microprocessor may have an instruction format containing a bit-field (B12) which specifies an instruction (I10), and where instruction (I10) may have to enter a certain pipeline stage either before or after instruction (I9) enters or is allowed to enter a certain pipeline stage,
where the meaning of the bit-field (B12) may depend on the meaning of other bit-fields of the instruction format of any instruction of said instruction set,
where said microprocessor may have an instruction which, when it enters a certain pipeline stage, indicates that certain symbolic variables (Sk) are no longer used and that the values of symbolic variables (Sk) may be overwritten
where one or more instructions of the instruction set of said microprocessor may have an instruction format containing a bit-field (B14) which specifies whether or not a symbolic variable specified as instruction result may be allocated to the same register as the one to which one of the instruction operands is allocated
where one or more instructions of the instruction set of said microprocessor may have an instruction format containing a bit-field (B15) which specifies whether or not the value of a symbolic variable (sv4) specified as instruction result is the value of the definition address of said symbolic variable (sv4)
where one or more instructions of the instruction set of said microprocessor may have an instruction format containing a bit-field (B16) which specifies whether or not the value of a symbolic variable specified as instruction result is the value of a predication variable
where one or more instructions of the instruction set of said microprocessor may have an instruction format containing a bit-field (B17) which specifies whether or not the value of a symbolic variable specified as instruction result corresponds to a branch address

11. A method as claimed in claim 5.,
where one or more instructions of the instruction set of said microprocessor may have an instruction format containing a bit-field (B10) which indicates:
whether the value of an instruction operand is stored in a register file or not
or whether the value of an instruction operand has to be written into a register file or not
or whether the value of an instruction result has to be written into a register file or not
and where said instruction operand and said instruction result specify a symbolic variable,
where the meaning of the bit-field (B10) may depend on the meaning of other bit-fields of the instruction format of any instruction of said instruction set,
where one or more instructions of the instruction set of said microprocessor may have an instruction format containing a bit-field (B11) which indicates whether a symbolic variable specified by an operand and/or result of an instruction (I7) is specified by an operand and/or result of another instruction (I8) or not, and where instruction (I8) may enter or may have to enter a certain pipeline stage either before or after instruction (I7) enters or is allowed to enter a certain pipeline stage, where the meaning of the bit-field (B11) may depend on the meaning of other bit-fields of the instruction format of any instruction of said instruction set,
where one or more instructions of the instruction set of said microprocessor may have an instruction format containing a bit-field (B13) which indicates whether a symbolic variable specified by an instruction operand and/or an instruction result is data dependent or not,
where the meaning of the bit-field (B13) may depend on the meaning of other bit-fields of the instruction format of any instruction of said instruction set,
where at least one instruction (I9) of the instruction set of said microprocessor may have an instruction format containing a bit-field (B12) which specifies an instruction (I10), and where instruction (I10) may have to enter a certain pipeline stage either before or after instruction (I9) enters or is allowed to enter a certain pipeline stage,
where the meaning of the bit-field (B12) may depend on the meaning of other bit-fields of the instruction format of any instruction of said instruction set,
where said microprocessor may have an instruction which, when it enters a certain pipeline stage, indicates that certain symbolic variables (Sk) are no longer used and that the values of symbolic variables (Sk) may be overwritten
where one or more instructions of the instruction set of said microprocessor may have an instruction format containing a bit-field (B14) which specifies whether or not a symbolic variable specified as instruction result may be allocated to the same register as the one to which one of the instruction operands is allocated
where one or more instructions of the instruction set of said microprocessor may have an instruction format containing a bit-field (B15) which specifies whether or not the value of a symbolic variable (sv4) specified as instruction result is the value of the definition address of said symbolic variable (sv4)
where one or more instructions of the instruction set of said microprocessor may have an instruction format containing a bit-field (B16) which specifies whether or not the value of a symbolic variable specified as instruction result is the value of a predication variable
where one or more instructions of the instruction set of said microprocessor may have an instruction format containing a bit-field (B17) which specifies whether or not the value of a symbolic variable specified as instruction result corresponds to a branch address

12. A microprocessor as claimed in claim 6,
where one or more instructions of the instruction set of said microprocessor may have an instruction format containing a bit-field (B10) which indicates:
whether the value of an instruction operand is stored in a register file or not
or whether the value of an instruction operand has to be written into a register file or not
or whether the value of an instruction result has to be written into a register file or not
and where said instruction operand and said instruction result specify a symbolic variable,
where the meaning of the bit-field (B10) may depend on the meaning of other bit-fields of the instruction format of any instruction of said instruction set,
where one or more instructions of the instruction set of said microprocessor may have an instruction format containing a bit-field (B11) which indicates whether a symbolic variable specified by an operand and/or result of an instruction (I7) is specified by an operand and/or result of another instruction (I8) or not, and where instruction (I8) may enter or may have to enter a certain pipeline stage either before or after instruction (I7) enters or is allowed to enter a certain pipeline stage, where the meaning of the bit-field (B11) may depend on the meaning of other bit-fields of the instruction format of any instruction of said instruction set,
where one or more instructions of the instruction set of said microprocessor may have an instruction format containing a bit-field (B13) which indicates whether a symbolic variable specified by an instruction operand and/or an instruction result is data dependent or not,
where the meaning of the bit-field (B13) may depend on the meaning of other bit-fields of the instruction format of any instruction of said instruction set,
where at least one instruction (I9) of the instruction set of said microprocessor may have an instruction format containing a bit-field (B12) which specifies an instruction (I10), and where instruction (I10) may have to enter a certain pipeline stage either before or after instruction (I9) enters or is allowed to enter a certain pipeline stage,
where the meaning of the bit-field (B12) may depend on the meaning of other bit-fields of the instruction format of any instruction of said instruction set,
where said microprocessor may have an instruction which, when it enters a certain pipeline stage, indicates that certain symbolic variables (Sk) are no longer used and that the values of symbolic variables (Sk) may be overwritten
where one or more instructions of the instruction set of said microprocessor may have an instruction format containing a bit-field (B14) which specifies whether or not a symbolic variable specified as instruction result may be allocated to the same register as the one to which one of the instruction operands is allocated
where one or more instructions of the instruction set of said microprocessor may have an instruction format containing a bit-field (B15) which specifies whether or not the value of a symbolic variable (sv4) specified as instruction result is the value of the definition address of said symbolic variable (sv4)
where one or more instructions of the instruction set of said microprocessor may have an instruction format containing a bit-field (B16) which specifies whether or not the value of a symbolic variable specified as instruction result is the value of a predication variable
where one or more instructions of the instruction set of said microprocessor may have an instruction format containing a bit-field (B17) which specifies whether or not the value of a symbolic variable specified as instruction result corresponds to a branch address
